(19) United States
(12) Patent Application Publication
(10) Pub. No.: US 2002/0152262 A1
(43) Pub. Date: Oct. 17, 2002

(54) Method and system for preventing the infringement of intellectual property rights

(76) Inventors: Jed Arkin, Silver Spring, MD (US); Rona Frank, Bellevue, WA (US); Kurt Inderbitzin, Los Angeles, CA (US)

Correspondence Address: TESTA, HURWITZ & THIBEAULT, LLP, HIGH STREET TOWER, 125 HIGH STREET, BOSTON, MA, 02110, US

(21) Appl. No.: 09/977,863

(22) Filed: Oct. 15, 2001

Related U.S. Application Data
(63) Continuation-in-part of application No. 09/836,879, filed on Apr. 17, 2001.

(51) Int. Cl. G06F 15/16; G06F 15/173

(52) U.S. Cl. 709/202; 709/225; 709/229

(57) ABSTRACT

System for preventing the infringement of intellectual property rights including a searching server for identifying an infringing item in a network, a production server for producing modified copies of IP protected items and a sharing structure for sharing the modified copies over the network. The sharing structure includes a plurality of repositories and a plurality of sharing users. The repositories are mainly storage units storing many copies of the modified copies. The sharing users share the modified copies over the network either by uploading the modified copies from the repositories through to a downloading node across the network, or by directing the downloading node to download directly from the repositories.

### CROSS REFERENCE

This application is a continuation-in-part of U.S. patent application Ser. No. 09/836,879 filed on Apr. 17, 2001 and entitled ‘Method and System for Preventing the Infringement of Intellectual Property Rights’, the entire contents of which is incorporated herein by reference.

### FIELD OF THE INVENTION

The present invention relates to networks in general, and to methods and systems for preventing intellectual property rights infringement of computer objects, in particular.

### BACKGROUND OF THE INVENTION

The use of the Internet by the general public, and with it the World Wide Web, is growing at an exponential rate. According to an NUA survey, as of July 2000, there were 333 million users world wide. A large percentage of these users regularly post on the Internet, electronic objects or a part thereof, such as software, surveys, pictures, music, films, animations, novels, poems and research reports. Some of these items are intellectual property and are protected by intellectual property legislation, such as copyright, Trademarks, patents, and the like.

Methods and systems which try to circumvent the problem of copyright infringement, are known in the art. Some of these methods employ encryption as a means to prevent the use of copyrighted material by unauthorized persons. Others employ public-private keys, passwords or embedded electronic signatures. A musical band, called “Bare Naked Ladies” distributed files bearing the names of their own music tracks in the Napster network, and attached a warning statement to each of these files, which notified the user that she is infringing Intellectual Property (IP) protected rights.

U.S. Pat. No. 6,119,108 entitled “Secure Electronic Publishing System” issued to Holmes et al., is directed to a method for charging a user for the use of an electronic object through the Internet. When the user attempts to open the object, access to the object is interrupted and she is connected with the purchasing authority system, to conduct a financial transaction therewith. If the user is interested in opening the electronic object, she supplies her personal information such as name, address, and telephone number, as well as payment information such as credit card information. Then the user is given a password to access the object. Other users can likewise gain access to the object by obtaining a personal password from the purchasing authority system. Hence, only those users who have arranged payment, can access a specific object on the Internet.

U.S. Pat. No. 5,987,126 issued to Okuyama et al., and entitled “Device Having a Digital Interface and a Network System Using Such a Device and a Copy Protection Method”, is directed to a method for controlling the recording of sound or video, according to copy generation management information. A first and a second sending (reproduction) device are connected to a receiving (recording) device, via an IEEE 1394 standard bus.

The first sending device includes a reproduction processing circuit, a D-interface format output processing circuit, an IEEE 1394 interface and a copy flag detecting circuit. The D-interface format output processing circuit, the IEEE 1394 interface and the copy flag detecting circuit are interconnected. The reproduction processing circuit is connected to a reproduction device and to the D-interface format output processing circuit. The second sending device includes a decoding circuit, an MPEG output processing circuit, an IEEE 1394 interface and a copy flag detecting circuit. The MPEG output processing circuit, the IEEE 1394 interface and the copy flag detecting circuit are interconnected. The decoding circuit is connected to a reproduction device and to the MPEG output processing circuit.

The receiving device includes a IEEE 1394 interface, a format converting circuit, a recording processing circuit, a copy generation circuit and a recording controlling circuit. The IEEE 1394 interface includes a copy flag detector. The copy flag detector is connected to the copy generation circuit and to the recording controlling circuit. The recording processing circuit is connected to the recording controlling circuit and to the format converting circuit. The format converting circuit is connected to the copy generation circuit and to the IEEE 1394 interface. The IEEE 1394 interfaces of the first and the second sending devices are connected to the IEEE1394 interface of the receiving device via the IEEE 1394 bus.

The copy flag detecting circuit of the first and the second device detects the copy generation management information embedded in the source control packet, and sends this information to copy flag detector of the receiving device via the IEEE 1394 interface. For example, if the copy generation management information detected by the copy flag detector is “11”, which prohibits copying, then the recording processing circuit of the receiving device controls the operation of the servo circuit, so as to prohibit recording.

U.S. Pat. No. 5,867,579 issued to Saito and entitled “Apparatus For Data Copyright Management System”, is directed to a system to manage data which are protected by copyright. The system includes a key control center connected to a read only memory (ROM), a read and write memory (RAM) and to an electrically erasable programmable read only memory (EEPROM) via a local bus. The system bus of a user terminal is connected to the local bus of the system. The user terminal includes an MPU connected to a communication unit (COMM), a CD-ROM drive (CDRD), a flexible disk drive (FDD) and to a hard disk drive (HDD), via the system bus.

Fixed information such as data copyright management program, a cryptography program, user data, a decryption program, a re-encryption program and a program for generating secret keys are stored in the ROM. A crypt key and the copyright information are stored in the EEPROM. Either one of the first crypt-key or the second crypt-key and data copyright management system program are stored in the RAM of the system and in the RAM of the user terminal.

A primary user receives the first secret-key as a decryption key and the second secret-key as an encryption/decryption key. The encrypted original data is decrypted using the first secret-key. When the data is stored in a memory or in a hard disk drive, only the primary user can use the data. When the original data or the edited data is stored in the memory of the primary user terminal, only the primary user can use the data. When the original data is copied and supplied to a secondary user, the copyright of the primary user is not affected on the original data.

When the primary user produces an edited data by editing the original data or combining the original data with other data, the secondary exploitation right of the primary user (i.e., the copyright of the primary user) is affected. The primary user, then requests a second-key from the key control center. Thereafter, the primary user decrypts and encrypts the data, using the secondary secret-key. Similarly, when the secondary user produces an edited data from the original data, or edits the data obtained from the primary user, the copyright of the secondary user is affected. The secondary user can use the data, by designating the original data name or data number, the secondary user information and the unencrypted primary user information to the copyright management center. The copyright management center confirms that the primary user has received the second secret-key, and then transfers the second secret-key to the secondary user.

U.S. Pat. No. 5,790,236 issued to Hershtik et al., and entitled “Movie Processing System”, is directed to a method and a system for modifying the soundtrack or the picture frames of a video, by producing respective sound and frame characteristics. Initially, different versions of a movie are entered to the system. The resolution of each version is reduced, for each version a plurality of sound characteristics and frame characteristics are produced and these characteristics are stored in a memory. A movie version synchronizer analyzes the frame characteristics and produces indications of all the movie versions for which different movie segments appear.

An output movie editing list generator produces an editing list such as “intersection”, “union” or “complement to reference”, according to the output of the movie version synchronizer. An icon incorporation unit can use the “complement to reference” list to incorporate an icon with the frames, to indicate the language version of the movie. A reduced resolution video editing workstation employs the “intersection” editing list of the output movie editing list, to provide a high resolution video editing workstation, with the same movie segments which appear in different languages. The high resolution video editing workstation produces an output movie which includes a single video track and a plurality of soundtracks in different languages.

U.S. Pat. No. 5,892,825 issued to Mages et al., and entitled “Method of Secure Server Control of Local Media Via a Trigger Through a Network for Instant Local Access of Encrypted Data on Local Media”, is directed to a method to enable reading of a CD-ROM whose reading had been previously disabled. A user is originally supplied with a crippled CD-ROM whose audio/video header is removed, thus preventing the computer of the user to read these audio/video data. The crippled CD-ROM includes the uniform resource locator (URL) of the web site which can provide the user with a de-crippling key. The user initiates a socket-to-socket connection between her computer and the server of the web site, and the de-crippling key is transmitted to the computer and stored in the RAM thereof. In RAM, the de-crippling key and the data of the CD-ROM are combined, thereby enabling the playback of the audio/video data.

U.S. Pat. No. 5,787,068 issued to Arps et al., and entitled “Method and Arrangement for Preventing Unauthorized Duplication of Optical Discs Using Barriers”, is directed to a method for preventing unauthorized copying of data recorded on optical discs, such as CD-ROM. In a conventional CD-ROM, data is recorded contiguously in a spiral track. According to this patent, gaps and barriers or decoy files are placed between real data files and a directory is recorded at the beginning of the spiral track, which includes pointers to each of the real files. An optical reading head which attempts to read the data, derails from the track when it encounters these gaps and barriers, and thus unauthorized reading of data is prevented. Authorized reading is facilitated by the pointers of the directory which instruct the reading head to read the data files non-contiguously.

U.S. Pat. No. 5,923,763 issued to Walker et al., and entitled “Method and Apparatus for Secure Document Timestamping”, is directed to a method and a system to prevent forging of documents, by generating a timestamp for the document. The system includes a cryptographic processor, a random number generator, a clock, a signal receiver, an internal power source, a RAM memory and a non-volatile memory interconnected via a bus. The system is connected to an input device, such as a push button, an output device, such as a printer and to an external power source, via the bus. The clock is either internal or external, such as the timing signal of a global positioning system (GPS) and the US Observatory atomic clock.

The system creates a timestamp according to a request from the input device and outputs the timestamp to the output device. The cryptographic processor generates a timestamp from the clock and outputs the timestamp consisting of the cleartext time, plus a one way function which represents the time. The one way function can be a hash, a message authenticity code (MAC) and a cyclic redundancy check (CRC). The one way function allows one to determine if the document has been tampered. The hashing algorithm can be stored either in the RAM or in the non-volatile memory.

The user produces a chained hash for the document, whose timestamp includes for example, three consecutive dates. If a forger discovers the private key of the user and alters the timestamp of one of these dates, then the user can recompute the subsequent three timestamps and compare them with their known values. If the known timestamp and the computed timestamp disagree, the user can determine that the timestamp of one of these dates has been altered. The forger can change all the timestamps in the chained hash, but this requires more effort than changing the desired one, and also increases the chances of detection. The random number generator generates random numbers to prevent generation of reused timestamps.

U.S. Pat. No. 6,047,242 issued to Benson, and entitled “Computer System for Protecting Software and a Method for Protecting Software”, is directed to a method for purchasing software which is protected by electronic copy and license protection (ECP). The customer downloads a protected software from the vendor, the customer sends a registration package to the vendor, and the vendor generates a keyfile for the customer and sends the keyfile to the customer.

A challenge mechanism is embedded in the protected software, such that an attacker can not easily separate the challenge mechanism from the protected software. The public keying material of the vendor is embedded in the challenge mechanism. The vendor signs both the protected software and the challenge mechanism, using her private key. The registration package includes a reference to a public directory which holds the public keying material of the customer.

The keyfile includes the public keying material of the customer along with thousands of decoy bits. The customer information is embedded in the keyfile, in encrypted form, while the encryption key is not disclosed. The vendor can identify the owner of the keyfile, when the keyfile appears in a public location, such as a bulletin board. The vendor signs the keyfile, by employing a keyfile generator, the private keying material of the vendor and by applying a digital signature algorithm. When the customer installs the keyfile, the challenge mechanism allows the customer to execute the protected software, if the customer can prove that she has access to the private keying material of the customer.

Distributed networks, such as Gnutella, are known in the art. A user can search any type of item, such as an audio title, a video title or a software module, in this distributed network and download the item from another user connected to the network. Such a network typically includes a plurality of nodes, wherein some of the nodes serve as users and the rest serve as network servers. All of the nodes operate according to a distributed network protocol. Each of the users can include items which are offered to other users for sharing via the network. Each of the network servers includes a logged-on list which records the network protocol addresses of those users who were logged-on to the network or to a certain network server, most recently.

A downloading user which intends to download an item from another user, sends a logged-on query to one of the network servers. The network server, in turn sends at least a portion of the logged-on list to the downloading user. The downloading user searches the queried item in each of the users listed in the logged-on list, by sending an item query to each of these users. Each of the users which received the item query can forward that item query to additional users, not included in the logged-on list, thereby broadening the scope of the search.

Each of the users in which the queried item resides and is shared, responds to the item query by sending an item query response to the downloading user. The item query response includes information respective of the responding user and the requested item itself, such as the ping of the user, the size of the requested item, and the like. The downloading user selects a user according to the item query responses and sends an upload request to the selected user, to upload the requested item. The selected user, then uploads the queried item to the downloading user.

### SUMMARY OF THE PRESENT INVENTION

It is an object of the present invention to provide a novel method and system for preventing the infringement of intellectual property rights, which overcomes the disadvantages of the prior art. In accordance with one aspect of the present invention, there is thus provided a searching server for identifying an infringing item in a network. The searching server includes a sniffing user and a characteristics database. The sniffing user is coupled to the network and the characteristics database is coupled to the sniffing user.

The characteristics database includes Intellectual Property (IP) item characteristics of IP items. The sniffing user detects an infringing item using a directory available on the network. The sniffing user retrieves infringing item characteristics from the network. The searching server identifies the infringing item, by comparing the infringing item characteristics with the IP item characteristics.

In accordance with another aspect of the present invention, there is thus provided a system for producing IP item modified copies. The system includes a network interface and a processor. The network interface is coupled to a network and to the processor. The processor produces modified copies from IP items and the modified copies are made available to the network via the network interface.

In accordance with a further aspect of the present invention, there is thus provided a modified item. The modified item includes modified item characteristics and modified item content. The modified item is produced according to at least one item characteristics, item content and supplementary material.

In accordance with another aspect of the present invention, there is thus provided a system for sharing items in a network. The system includes at least one storage unit for storing modified copies of a plurality of items and at least one network interface coupled to one of the storage units and to the network. Each network interface is associated with a different selection of modified copies. Each network interface shares the modified copies associated therewith, over the network.

In accordance with a further aspect of the present invention, there is thus provided a method for reducing the probability for identifying an item in a network. The method includes the steps of associating a plurality of network interfaces with modified copies of items and enabling the availability of the modified copies through the network interfaces.

In accordance with another aspect of the present invention, there is thus provided a method for detecting an infringing copy of an IP item in a network. The method includes the steps of inspecting a search result for identifying the infringing copy and comparing at least one infringing copy characteristic of the infringing copy, with at least one IP item characteristic of the IP item, when the infringing copy is identified.

In accordance with a further aspect of the present invention, there is thus provided a repository network node, for communicating with a plurality of network nodes over a network, wherein selected ones of these network nodes are repository network nodes. The repository network node includes a network interface coupled to the network and a processor coupled to the network interface.

The network interface receives an item query from another network node via the network, and the processor forwards the item query to selected ones of these repository network nodes, when the item query is directed at IP protected items. The processor forwards the item query to selected non repository network nodes of these network nodes, when the item query is not directed at IP protected items.

In accordance with another aspect of the present invention, there is thus provided a repository network node, selected from a plurality of repository network nodes, wherein the repository network nodes communicate with a plurality of network nodes over a network. The repository network node includes a network interface coupled to the network and a processor coupled to the network interface.

The processor receives item queries related to IP protected items, from the network nodes, via the network interface and sends information respective of these item queries, to a network control node. The network control node uses this information to control the operation of selected ones of these repository network nodes.

In accordance with a further aspect of the present invention, there is thus provided a network control node, for controlling the operation of a plurality of repository network nodes, wherein the repository network nodes communicate with a plurality of network nodes over a network. The network control node includes a network interface coupled to the network and a processor coupled to the network interface.

The network control node receives information from the repository network nodes, respective of item queries related to IP protected items, wherein the repository network nodes receive these item queries from the network nodes. The network control node, in turn controls the operation of the repository network nodes according to this information.

In accordance with another aspect of the present invention, there is thus provided a network control node, for balancing the load among a plurality of repository network nodes. The repository network nodes communicate with a plurality of network nodes over a network. The network control node includes a network interface coupled to the network and a processor coupled to the network interface.

The network control node receives an activity report from each of the repository network nodes, wherein the activity report is respective of item queries which the repository network nodes receive from each of the network nodes and the item queries are related to IP protected items. The network control node balances the load among the repository network nodes, by comparing the activity report of one repository network with activity reports of other repository network nodes.

In accordance with a further aspect of the present invention, there is thus provided a modified item. The modified item includes at least one modified item characteristic and modified item content, wherein the modified item is produced according to at least one item characteristic of an item, item content of the item and at least one supplementary material.

The supplementary material is a notice that the modified item is a modified copy of an IP protected item. Alternatively, the supplementary material is a purchase offer for a network node which downloads the modified item, to purchase a usable copy of the modified item. Further alternatively, the supplementary material includes a link to a network site, wherein the network site includes a purchase offer for the network node which downloads the modified item, to purchase a usable copy of the modified item. Yet alternatively, the supplementary material includes a membership offer for the network node which downloads the modified item, to operate similar to a repository network node. The supplementary material is in such forms as text, graphics, animation, voice, and the like.

In accordance with another aspect of the present invention, there is thus provided a method for uploading an item to a network node over a network. The method includes the steps of determining the type of the item and forwarding an item query to a plurality of selected repository network nodes which belong to a selected group of repository network nodes, when the item is IP protected. Alternatively, the method includes the step of forwarding the item query to a plurality of other repository network nodes which do not belong to the selected group of repository network nodes, when the item is not IP protected.

In accordance with a further aspect of the present invention, there is thus provided a method for purchasing an IP protected item over a network. The method includes the step of encrypting the IP protected item according to an encryption key, wherein the encryption key is determined according to user sensitive information.

In accordance with another aspect of the present invention, there is thus provided a method for uploading a modified copy of an infringing item to a network node, over a network. The method includes the step of uploading the modified copy from a repository network node, when the repository network node is not occupied, and sending an upload request by the repository network node to a network control node, when the repository network node is occupied.

In accordance with a further aspect of the present invention, there is thus provided a method for rewarding a repository network node coupled to a network, for uploading an item to a network node coupled to the network. The method includes the steps of analyzing uploading parameters received from the repository network node, determining a reward according to the analysis of the uploading parameters, and uploading the reward to the repository network node.

### BRIEF DESCRIPTION OF THE DRAWINGS

The present invention will be understood and appreciated more fully from the following detailed description taken in conjunction with the drawings in which:

FIG. 1 is a schematic illustration of an item sharing server, constructed and operative in accordance with a preferred embodiment of the present invention;

FIG. 2 is a schematic illustration of a production server, constructed and operative in accordance with another preferred embodiment of the present invention;

FIG. 3 is a schematic illustration of a computer system, constructed and operative in accordance with a further preferred embodiment of the present invention;

FIG. 4A is a schematic illustration of an item sharing server, constructed and operative in accordance with another preferred embodiment of the present invention;

FIG. 4B is a schematic illustration of an item sharing server, constructed and operative in accordance with a further preferred embodiment of the present invention;

FIG. 5 is a schematic illustration of an item sharing server, constructed and operative in accordance with another preferred embodiment of the present invention;

FIG. 6 is a schematic illustration of a method for proliferating unusable copies of an item in a network, operative in accordance with a further preferred embodiment of the present invention;

FIG. 7 is a schematic illustration of step 400 of FIG. 6, operative in accordance with another preferred embodiment of the present invention;

FIG. 8 is a schematic illustration of a computer system, constructed operative in accordance with a further preferred embodiment of the present invention;

FIG. 9 is a schematic illustration of a computer system, constructed operative in accordance with another preferred embodiment of the present invention;

FIG. 10 is a schematic illustration of a computer system, constructed operative in accordance with a further preferred embodiment of the present invention;

FIG. 11 is a schematic illustration of a computer system, constructed and operative in accordance with another preferred embodiment of the present invention;

FIG. 12 is a schematic illustration of a method for uploading a queried item to a network node, operative in accordance with a further preferred embodiment of the present invention;

FIG. 13 is a schematic illustration of a method for purchasing an IP protected item, operative in accordance with another preferred embodiment of the present invention;

FIG. 14 is a schematic illustration of a method for uploading an infringing item to a network node, operative in accordance with a further preferred embodiment of the present invention;

FIG. 15 is a schematic illustration of a method for rewarding a repository network node, operative in accordance with another preferred embodiment of the present invention; and

FIG. 16 is a schematic illustration of a network node display, constructed and operative in accordance with a further preferred embodiment of the present invention.

### DETAILED DESCRIPTION OF PREFERRED EMBODIMENTS

The present invention overcomes the disadvantages of the prior art by providing a system and a method which reduce the probability of accessing an intellectual property (IP) infringing object, on an information network, by distributing a large number of modified mockup copies of that IP infringing object, bearing the same characteristics. Accordingly, a user searching for the IP infringing object would receive a search list which includes a large number of the modified mockup copies and may also include the IP infringing object, from which the user selects an object to download. Provided that the modified mockup copies outnumber the copies of the IP infringing object, available on the network, then the probability of downloading the IP infringing object and not one of the modified mockup copies shall be significantly low. This low probability may discourage the user from downloading after a few unsuccessful attempts.

The term “IP protected item” herein below, refers to an item protected by copyright or other intellectual property rights, for which a user owns a valid license on behalf of the owner of the item, to use the item. The term “infringing item” herein below, refers to an item or an object, which incorporates intellectual property rights, that may be infringed by the user which makes that item available on the network.

The term “supplementary material” herein below, refers to a portion of a media object or a collection of such portions, which is included in a modified item. The supplementary material can be an advertisement, a commercial promotion, a movie trailer, a link to legitimate sites, a warning statement which states that the downloaded object incorporates proprietary intellectual property rights, and the like, or a combination thereof. The warning statement can be in the form of text, graphics, video, animation, sound, and the like, or a combination thereof.

Furthermore, the supplementary material is a purchase offer to purchase an IP protected copy of the item which a user downloads. Further alternatively, the supplementary material includes one or more links to sites on the network. Each site includes a membership offer and a purchase offer. The membership offer invites the user to join a group of users who generally upload modified copies of IP protected items to other users. The purchase offer which is included in the site, makes a suggestion to the user which downloads the modified copy of an item, to purchase the IP protected copy of the item.

The term “usable” herein below, refers to an item whose content can be properly and entirely comprehended by a person to her satisfaction, when she opens the item on her user terminal and interacts therewith, using at least one of the five senses. The term “unusable” herein below, refers to an item whose content can not be properly and entirely comprehended or utilized by the person to her full satisfaction, when she attempts to interact therewith. An item can be rendered unusable, for example if it is a video, by changing the original sequence of the scenes. Thus, although the content of the unusable copy is identical with the content of the usable one, the person will not comprehend the theme of the video, even after viewing the entire unusable copy.

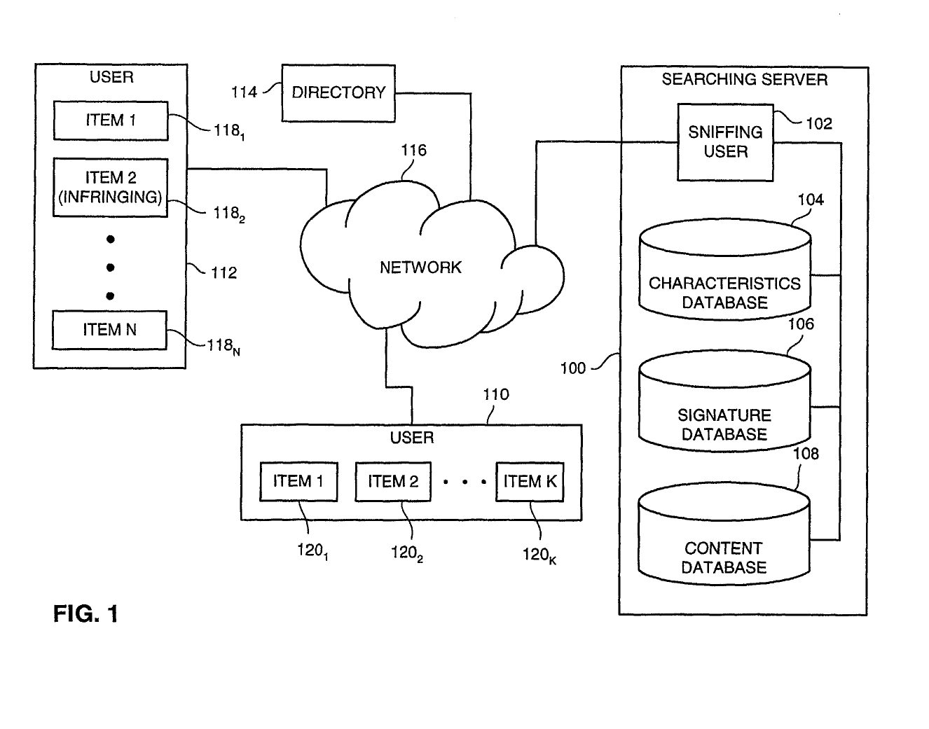

Reference is now made to FIG. 1, which is a schematic illustration of an item sharing server, generally referenced 100, constructed and operative in accordance with a preferred embodiment of the present invention. Searching server 100 includes a sniffing user 102, a characteristics database 104, a signature database 106 and a content database 108. Sniffing user 102 is coupled to a network 116, characteristics database 104, signature database 106 and to content database 108.

Searching server 100, a user 110, a share-infringing user 112 and a directory 114 are coupled to network 116, by a wired or wireless link, or a combination thereof. Network 116 is a publicly accessed network (e.g., the Internet) or network application (e.g., Napster, Gnutella, Scour, Freenet, imesh, and the like). Directory 114 is either a central directory, a search engine, or a distributed directory, spreading over a plurality of nodes in network 116. User 110 and share-infringing user 112 are workstations, desktops, laptops, mobile units, network user applications, and the like.

Users which are connected to network 116, can download items from one another. Each of these users can download an item from another user either directly (peer to peer), or indirectly through a mediator (e.g., through directory 114). For example, user 110 can download an infringing ITEM-2 118₂ from share-infringing user 112, thereby infringing intellectual property rights. Share-infringing user 112 can infringe IP rights by sharing infringing ITEM-2 118₂ with other users (not shown) and also by downloading other infringing items (not shown) from these other users.

A digital item is a digital entry, file, or object which can be processed by user 110, share-infringing user 112 and searching server 100 and downloaded from one user to another, either directly, or via a mediating node. A digital item can be in a format known in the art, such as MIDI, WAV, AVI, MPEG, JPEG, ASCII, TIFF, GIF, PDF, RTF, bitmap, and the like, or a combination thereof.

Share-infringing user 112 includes a plurality of items, such as ITEM-1 118₁, ITEM-2 118₂ and ITEM-N 118_{N}. ITEM-2 118₂ is an infringing copy of ITEM-2 120₂. User 110 includes a plurality of IP protected items, such as ITEM-1 120₁, ITEM-2 120₂ and ITEM-K 120_{K}. The content of infringing ITEM-2 118₂ and IP protected ITEM-2 120₂ is substantially identical, while their format may be different. Thus, share-infringing user 112 can download IP protected ITEM-2 120₂ from user 110 and store it in share-infringing user 112 as infringing ITEM-2 118₂, without obtaining a license to use IP protected ITEM-2 120₂.

When user 110 and share-infringing user 112 are both connected to network 116, share-infringing user 112 requests directory 114 to search for ITEM-1 120₁, while a downloading application runs in both user 110 and share-infringing user 112. Directory 114 provides share-infringing user 112 with search results. The search results indicate that ITEM-1 120₁ resides in user 110. Share-infringing user 112, then downloads ITEM-1 120₁ from user 110.

Content database 108 includes the content (e.g., audio, video, software, computer games, data, e-books, and the like) of a plurality of IP protected items (e.g., copyright protected items). Signature database 106 includes the signature of each of the IP protected items residing in content database 108.

A signature is uniquely derived from the item, its content or characteristics. An example for such a signature is hereby described in conjunction with digital video in MPEG format. The signature is produced as a sequence of numbers, from the I-Frames (i.e., intra-frame). Each of the numbers in the sequence is calculated according to a given function on predetermined areas in a selected I-Frame. In case of analog video in other formats, such as PAL, SECAM, NTSC, and the like, the signature is produced from a plurality of frames, which indicate a significant change in the visible content, such as a new video shot. Thus, a signature indicates the content of an item, while occupying a volume substantially smaller than the item itself. Similar signatures can be produced for audio and other media types. Characteristics database 104 includes the characteristics of each of the IP protected items stored in content database 108. The characteristics are the metadata of an item, such as title, file size, category, date of production, producer, performer, and the like.

Searching server 100 is a repository of a plurality of items, whose contents are stored in content database 108. Searching server 100 is either the owner of these items, or is authorized by the owner of these items, to take certain actions concerning these items. These actions can include modifying the item, uploading the modified item to a third party, making a plurality of the modified item available to the public, and the like. The address of each of the users who owns an IP protected item can be stored in searching server 100 (e.g., incorporated with characteristics database 104). Thus for example, searching server 100 can include the information that user 110 is the owner of IP protected ITEM-1 120₁ and ITEM-2 120₂, and that any copy of these items retrieved from the address of user 110 are legitimate copies. Accordingly, server 100 can refrain from taking measures regarding the presence of ITEM-1 120₁ and ITEM-2 120₂ and their availability via user 110, provided user 110 has the right to share these items.

Sniffing user 102 retrieves selected characteristics of an IP protected item, from characteristics database 104. Sniffing user 102 retrieves for example, the following characteristics from characteristics database 104, for ITEM-2: “Donald Duck in Jail” for the title, “Walt Disney Productions” for the producer and “Video” for the type of the item.

Sniffing user 102 then searches for an infringing copy of ITEM-2 in network 116, by producing a query according to the selected characteristics of ITEM-2 and providing that query to directory 114. This process can be fully automated. Directory 114 provides search results respective of the query. The search results indicate that ITEM-2 118₂ and ITEM-2 120₂, whose characteristics are similar to the selected characteristics, reside in user 110 and share-infringing user 112, respectively. Sniffing user 102 determines that ITEM-2 118₂ is an infringing copy of ITEM-2.

For increasing the certainty that ITEM-2 118₂ is indeed infringing, sniffing user 102 performs a verification procedure. Sniffing user 102 downloads at least a portion of infringing ITEM-2 118₂ to a storage unit (not shown) located in searching server 100 and compares the content of the downloaded item with a reference item, which is suspected of being infringed.

For this purpose, searching server 100 produces a signature for the downloaded infringing ITEM-2 118₂. It is noted that the signatures of items bearing identical content, but being in different formats, is essentially identical. For example, searching server 100 produces the same signature for a copy of “Donald Duck in Jail” video in MPEG version, PAL version and NTSC version. Searching server 100 produces a signature for the downloaded infringing ITEM-2 118₂ and retrieves the signature of ITEM-2 from signature database 106. Searching server 100 compares the produced signature of infringing ITEM-2 118₂ with the retrieved signature of ITEM-2. If all or a part of the two signatures are identical, then searching server 100 saves the characteristics of infringing ITEM-2 118₂.

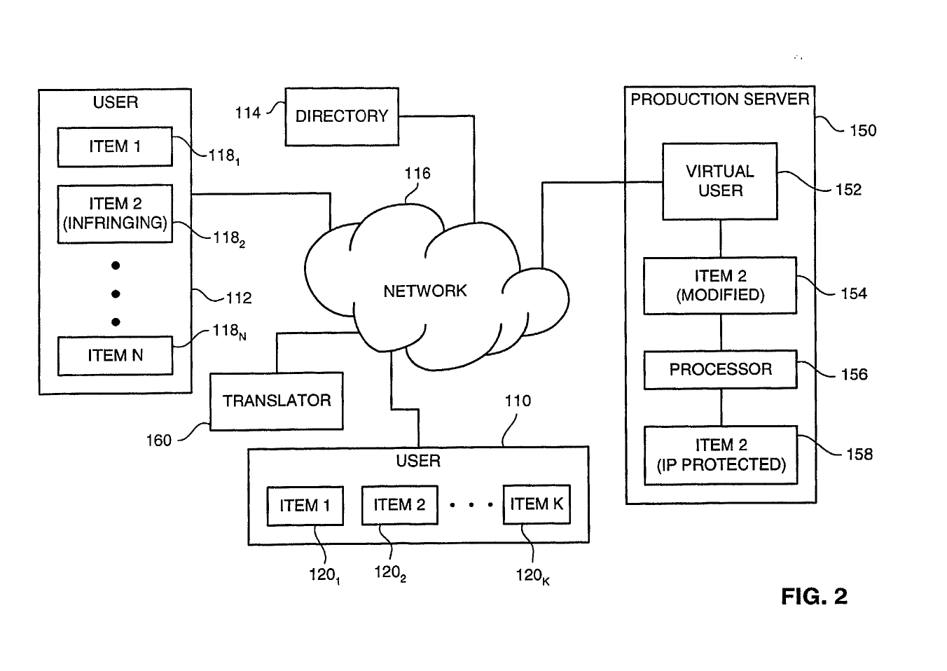

Reference is now made to FIG. 2, which is a schematic illustration of a production server, generally referenced 150, constructed and operative in accordance with another preferred embodiment of the present invention. Production server 150 includes a virtual user 152, a modified ITEM-2 154, a processor 156 and an IP protected ITEM-2 158. Virtual user 152 is coupled to network 116 and to modified ITEM-2 154. User 110, share-infringing user 112, directory 114, a translator 160 and production server 150 are coupled to network 116. Alternatively, virtual user 152 can be a network interface, a sharing user, and the like.

Translator 160 is an application, such as a web site, plug-in, and the like. Alternatively, translator 160 resides in user 110, share-infringing user 112 and in production server 150. Translator 160 produces a unique name for an item, according to the characteristics of the item, by employing a random key.

Processor 156 produces modified ITEM-2 154 by processing IP protected ITEM-2 158. Alternatively, processor 156 produces modified ITEM-2 154 by processing infringing ITEM-2 118₂. Modified ITEM-2 154 is an unusable copy of IP protected ITEM-2 158 (or infringing ITEM-2 118₂) having substantially the same characteristics (e.g., file name, file size, file type) as those of IP infringing ITEM-2 118₂. Thus, when user 110 searches network 116 for a copy of ITEM-2, it obtains search results which include infringing ITEM-2 118₂ and modified ITEM-2 154.

Directory 114 provides user 110 with information respective of the characteristics of infringing ITEM-2 118₂ and modified ITEM-2 154, such as title, file size, producer, and the like. However, because the characteristics of both infringing ITEM-2 118₂ and modified ITEM-2 154 are substantially the same, user 110 can not differentiate between the two, according to the information which it receives from directory 114.

Modified ITEM-2 154 can include out-of-sequence segments of IP protected ITEM-2 158 (or infringing ITEM-2 118₂), separated by one or more items of supplementary material. Alternatively, modified ITEM-2 154 can include out-of-sequence segments of IP protected ITEM-2 158, followed by one or more items of supplementary material. Further alternatively, the first portion of modified ITEM-2 154 can be a substantially small portion of the beginning of IP protected ITEM-2 158 and the rest of modified ITEM-2 154 can include recurring items of supplementary material. For example, if modified ITEM-2 154 is a video, it includes the first ten minutes of the original (IP protected) video, while the remainder includes recurring items of supplementary material. Thus, the modified copy is practically unusable. In all cases the size of modified ITEM-2 154 is substantially equal to the size of IP infringing ITEM-2 118₂.

It is noted that because the file size and other characteristics of the modified item are substantially identical with those of the IP protected item, a share-infringing user can not differentiate between the two items before and during the downloading of the modified item. The share-infringing user spends valuable resources to use an item which she later finds substantially unusable. Therefore, the share-infringing user is encouraged to arrange payment to the owner of the item, for downloading a legitimate copy of the item, or purchase a hard copy thereof.

According to another aspect of the present invention, production server 150 requests translator 160 to assign a translated name for modified ITEM-2 154. For example, if modified ITEM-2 154 is the “Donald Duck in Jail” cartoon, which was produced by Walt Disney Productions in 1966, then translator 160 assigns the name “ABC” for modified ITEM-2 154, according to the name of the cartoon, the producer and the year of production. Production server 150, then replaces the characteristics of modified ITEM-2 154 with the name “ABC”.

User 110, before searching for the “Donald Duck in Jail” cartoon, which was produced by Walt Disney Productions in 1966, provides translator 160 the characteristics of the cartoon and requests from translator 160, a translated name for this cartoon. Since the characteristics defined by production server 150 and user 110 for the cartoon are identical, translator 160 supplies the same name “ABC” for this cartoon, to user 110. User 110 searches network 116 for the item “ABC” and directory 114 notifies user 110 that item “ABC” (i.e., modified ITEM-2 154) resides in production server 150.

Infringing ITEM-2 118₂ is an infringing copy of the “Donald Duck in Jail” cartoon, which was produced by Walt Disney Productions in 1966. Share-infringing user 112 can request translator 160 to assign a translated name for infringing ITEM-2 118₂, by providing translator 160 the characteristics of the cartoon. Translator 160 supplies the name “ABC” for this cartoon, to share-infringing user 112. Share-infringing user 112, then replaces the characteristics of infringing ITEM-2 118₂ with the name “ABC”. In this case, when user 110 searches for the item “ABC” in network 116, directory 114 notifies user 110 that one copy of item “ABC” (i.e., modified ITEM-2 154) resides in production server 150, and another copy (i.e., infringing ITEM-2 118₂) resides in share-infringing user 112.

It is noted that production server 150 can initiate the production of mock-up copies as preemptive measures when a title is to be introduced to the public by the rightful owner, without searching for infringing copies. Furthermore, production server 150 can select a set of characteristics for the title, substantially identical with the characteristics which a share-infringing user generally selects for this type of title. For example, if a share-infringing user generally converts a legitimate WAV title of 50 Mbytes, to WAV format and in an MP3 compressed form of 3 Mbytes, then production server 150 produces the mock-up copy in MP3 format in a compressed form of 3 Mbytes.

According to another aspect of the present invention, production server 150 can produce different sets of mock-up copies of the title, while initiating the preemptive action. The characteristics of mock-up copies in one set is different from the characteristics of mock-up copies in another set. For example, each of the mock-up copies of the video “Donald Duck in Jail” in one set has the title “Donald Duck” and is compressed to 600 Mbytes, while each of the mock-up copies of the same video in another set has the title “Donald Duck in Prison” and is compressed to 100 Mbytes.

Share-infringing user 112 can attach a digital signature thereof, to infringing item 118₂ by employing a private key respective of that signature. Accordingly, any network user downloading infringing item 118₂, shall be able to authenticate infringing item 118₂ as an item provided or produced by share-infringing user 112, using the public key associated with that signature.

According to another aspect of the present invention, processor 156 obtains the signature characteristics of the signature of share-infringing user 112 (i.e., by deciphering it from a downloaded item, by downloading it from the network, and the like) and attaches that signature to modified ITEM-2 154. Hence, any user, which downloads modified ITEM-2 154 shall identify it as an authentic item of share-infringing user 112.

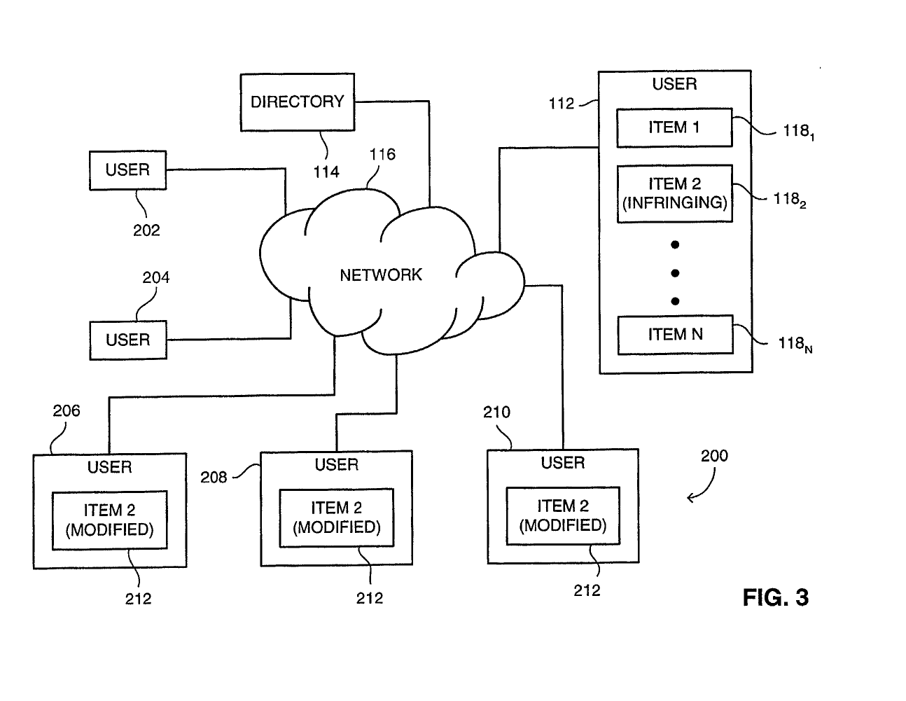

Reference is now made to FIG. 3, which is a schematic illustration of a computer system, generally referenced 200, constructed and operative in accordance with a further preferred embodiment of the present invention. System 200 includes distributed host users 206, 208 and 210 coupled to network 116. Download-infringing users 202, 204, share-infringing user 112 and directory 114 are coupled to network 116. Each of distributed host users 206, 208 and 210 includes a modified ITEM-2 212.

Modified ITEM-2 212 is similar to modified ITEM-2 154 (FIG. 2). ITEM-2 (not shown) is protected by intellectual property rights (e.g., copyright). Infringing ITEM-2 118₂ is a usable copy of ITEM-2, and modified ITEM-2 212 is an unusable copy of ITEM-2. When download-infringing user 202 searches for ITEM-2 through network 116, it detects four copies of ITEM-2, which are the infringing ITEM-2 118₂, and three copies of modified ITEM-2 212 in each of distributed host users 206, 208 and 210.

Directory 114 supplies download-infringing user 202 with information respective of the characteristics of infringing ITEM-2 118₂ and the three copies of modified ITEM-2 212, such as title, production date and file size. Since the characteristics of infringing ITEM-2 118₂ and the three copies of modified ITEM-2 212 are substantially identical, download-infringing user 202 can not differentiate between the four items and can not identify the three modified (unusable) ITEM-2's 212. In this situation, the probability that download-infringing user 202 shall download a usable copy of ITEM-2 (i.e., infringing ITEM-2 118₂) in one try, is only ¼ (i.e., 25%).

Download-infringing user 202 can identify modified copies of ITEM-2 212 according to the attributes of each of the distributed host users 206, 208 and 210. These attributes can be network interface card (NIC) identification, logical user name, the network service provider, network protocol address, and the like. In this manner, download-infringing user 202 can identify infringing ITEM-2 118₂, by elimination. Each of the distributed host users 206, 208 and 210 can periodically (e.g., every hour, once a week, or once a month), change the attributes thereof. Hence, the probability that download-infringing user 202 identifies the modified copies of ITEM-2 212, is substantially reduced.

When sniffing user 102 (FIG. 1), searches infringing ITEM-2 118₂ in network 116, directory 114 can identify sniffing user 102 according to the attributes thereof, and deny access of network 116 to sniffing user 102. Sniffing user 102 can periodically change the attributes thereof, thereby escaping identification by directory 114.

Each of the distributed host users 206, 208 and 210 can upload modified ITEM-2 212 to download-infringing user 202, at the request thereof, while varying the Quality of Service (QoS), provided to download-infringing user 202, during the upload process. For example, during the first few minutes of transmission, distributed host user 206 can upload modified ITEM-2 212 to download-infringing user 202, at a high rate of 50 kBytes/second. If, for example, the size of ITEM-2 212 is 15 Mbytes, then, the download should take about five minutes. Distributed host user 206 can then reduce the transfer rate, for the remainder of modified ITEM-2 212, to 1 kBytes/second, thereby drastically reducing the QoS and saving considerable bandwidth.

Distributed host user 206 initially uploads modified ITEM-2 212 at a high rate, in order to convince download-infringing user 202 that the QoS of the connection with distributed host user 206 is high and that it can download ITEM-2 212 fairly rapidly. Download-infringing user 202 continues the supposedly rapid download, only to determine at a later time, if at all, that the QoS of the connection has dropped considerably during the download of the remainder of modified ITEM-2 212.

Distributed host user 206 lowers the transmission bit rate of modified ITEM-2 212, in order to balance the load thereof. In this manner, distributed host user 206 can simultaneously upload modified ITEM-2 212 to download-infringing users 202 and 204 over the same high bandwidth channel and during high traffic periods.

If distributed host user 206 uploads modified ITEM-2 212 at an initial high bit rate and subsequent low bit rate, then download-infringing user 202 determines during the downloading process, that modified ITEM-2 212 is a useless copy of ITEM-2. Download-infringing user 202 might identify modified ITEM-2 212 as such and terminate the remaining download. In order to prevent download-infringing user 202 from identifying modified ITEM-2 212, distributed host user 206 alternates between the high and the low transmission bit rates. Thus, download-infringing user 202 determines that the varying transmission bit rate is an outcome of normal variations in traffic.

In some networks the users are requested to report the type of connection which links them to the network, to other nodes. A remote user or a server sends a bandwidth request to the user, which in turn replies with a bit rate value or connection type (e.g., cable, T1, T3, ISDN, 10BaseT, 100BaseT, and the like). According to a further aspect of the invention, distributed host user 206 uses this mechanism to mislead download-infringing users by reporting a certain bit rate, which may appeal to them, and then upload files at significantly reduced bit rates, thereto. With respect to FIG. 3, distributed host user 206 can report to directory 114, the type of connection thereof to network 116, via the downloading application. However, distributed host user 206 uploads modified ITEM-2 212 to download-infringing user 202 at a bit rate different than the one previously reported to directory 114. For example, distributed host user 206 can report to directory 114 that the connection thereof to network 116 is via a T1 trunk at 1.544 Mbits/second. However, distributed host user 206 uploads modified ITEM-2 212 to download-infringing user 202 at less than one kbit/second and vice versa.

According to another aspect of the present invention, directory 114 is a conventional search engine, such as Yahoo!, Alta Vista, Galaxy, GO.COM, and the like. In this case, when download-infringing user 202 searches for ITEM-2 using the search engine, the search result indicates that infringing ITEM-2 118₂ is located in share-infringing user 112 and a copy of modified ITEM-2 212 is located in each of distributed host users 206, 208 and 210.

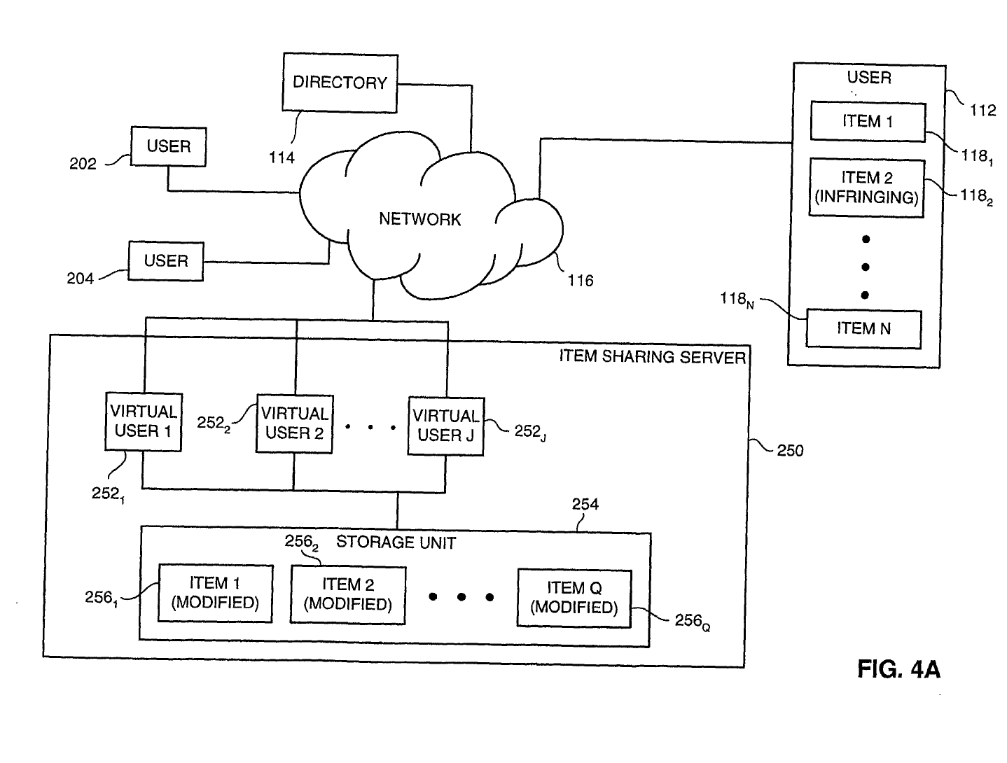

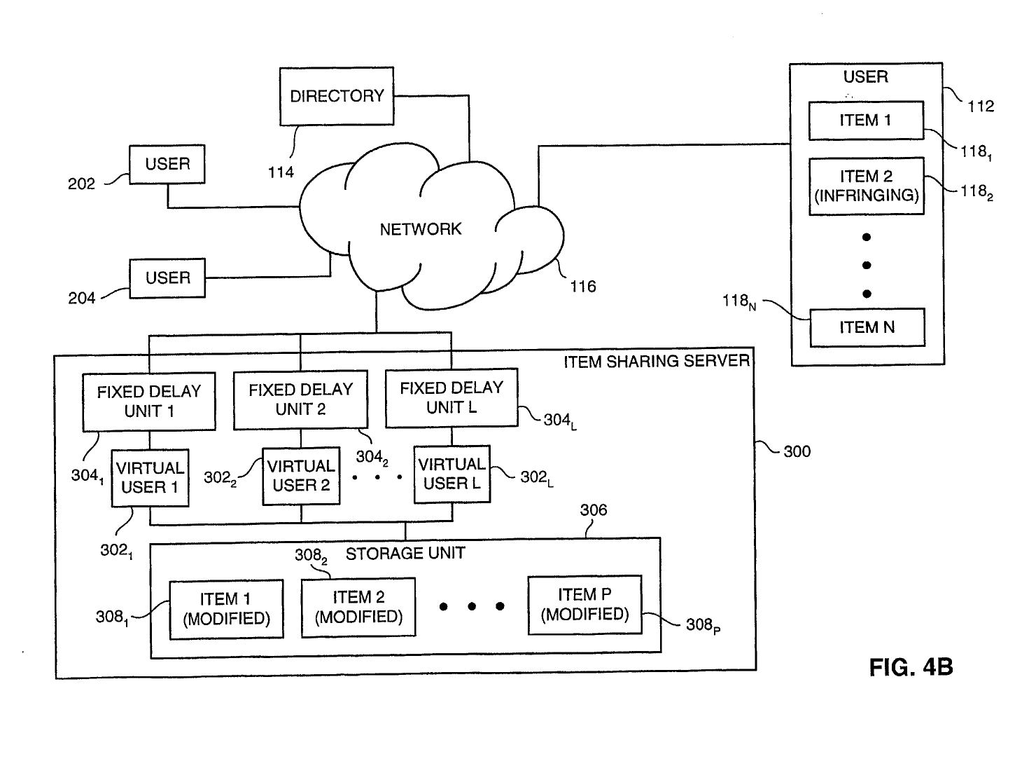

Reference is now made to FIG. 4A. FIG. 4A is a schematic illustration of an item sharing server, generally referenced 250, constructed and operative in accordance with another preferred embodiment of the present invention. Item sharing server 250 includes a plurality of virtual users 252₁, 252₂ and 252_{J} and a storage unit 254. Storage unit 254 includes a plurality of different modified items, such as ITEM-1 256₁, ITEM-2 256₂ and ITEM-Q 256_{Q} (Q is not necessarily equal to N of ITEM-N 118_{N})

Each of virtual users 252₁, 252₂ and 252_{J} is a software application which runs in item sharing server 250. However, over network 116 each of virtual users 252₁, 252₂ and 252_{J} is perceived as a hardwired user such as a desktop, laptop, workstation, mobile unit, network user applications, and the like, which has a unique URL, network protocol address (e.g. IP address), user name, MAC address, and the like.

Each of virtual users 252₁, 252₂ and 252_{J}, download-infringing users 202, 204, share-infringing user 112 and directory 114 are coupled to network 116. Each of virtual users 252₁, 252₂ and 252_{J} is coupled to storage unit 254. When download-infringing user 202 searches for ITEM-2 (not shown), directory 114 notifies download-infringing user 202 that a copy of ITEM-2 is located in each of the J virtual users 252₁, 252₂ and 252_{J}, and a copy of ITEM-2 118₂ is located in share-infringing user 112. It is noted that one ITEM-2 256₂ corresponds with each of the J virtual users 252₁, 252₂ and 252_{J}. Thus, the search result lists ITEM-2 256₂, J times, once for each of virtual users 252₁, 252₂ and 252_{J}, and lists ITEM-2 118₂ once for share-infringing user 112.

The characteristics of each of the J modified (unusable) ITEM2's 256₂, which supposedly resides in each of the J virtual users 252₁, 252₂ and 252_{J}, are identical with the characteristics of infringing (usable) ITEM-2 118₂. Thus, download-infringing user 202 can not determine which of the items in the search result are the modified (unusable) ones. In this case, the probability that download-infringing user 202 downloads infringing (usable) ITEM-2 118₂ in the first try, is n/(n+J), where n denotes the number of infringing copies of ITEM-2. The greater the number of virtual users 252₁, 252₂ and 252_{J}, the lower the probability that download-infringing user 202 downloads the infringing (usable) ITEM-2 118₂ in the first try.

When download-infringing user 202 searches for ITEM-1 118₁, the search result provided by directory 114 indicates that one ITEM-1 118₁ resides in share-infringing user 112 and J copies of ITEM-1 256₁, reside in each of virtual users 252₁, 252₂ and 252_{J}. The characteristics listed in the search result for ITEM-1 118₁ are identical with the characteristics listed for each of the J ITEM-1's 256₁. Thus, download-infringing user 202 can not determine which of the items are the modified (unusable) ones, only by cross-examining the characteristics of the items in the list.

The term “local user” herein below, refers to a user who searches for an item in a network, in order to download the item from another user connected to the network (herein below referred to as “remote user”). When a local user initiates a search for an item, the directory supplies a search result to the local user. The search result includes the characteristics of the items found, along with the URL, network protocol address, user name, media access control (MAC) address, and the like, of each of the remote users which includes an item. The downloading application running in the local user, initiates a “ping command” to the URL, network protocol address, user name, MAC address, and the like, of each of these remote users. When a remote user receives the ping command, it sends back an “ACK” signal to the local user. The local user application measures the time for the roundtrip from the instant it initiates the ping command until the time it receives the ACK signal and produces a “ping”. The ping time provides an indication to quality of the connection between the ping initiating node and the ping destination node. Thus, in order to expedite the download procedure, the local user can download a selected item from the remote user having the lowest ping in the list.

When the local user transmits a ping command to a remote user, a switched virtual connection (SVC) is established between the two users. When the local user initiates connection with the remote user to download an item, another SVC is established between the two, which can be different from the SVC established for transmitting the ping command. In this sense, the ping time indicates to the local user the download time from the remote user relative to other remote users, while this indication is true up to a certain probability.

Since the pings for the same remote user or remote users located substantially close, are equal, the local user can employ the pings, to determine whether two or more items are located in the same remote user. Since virtual users 252₁, 252₂ and 252_{J} are physically located at the same site (i.e., the physical location of item sharing server 250), the pings of virtual users 252₁, 252₂ and 252_{J} are essentially identical, for example 250 ms. If share-infringing user 112 is physically located at a location different than item sharing server 250, then the ping of share-infringing user 112 is different than the ping of virtual users 252₁, 252₂ and 252_{J} and it is for example, 300 ms. Download-infringing user 202 can determine that a plurality of J modified copies of ITEM-2 256₂ having identical pings of 250 ms, all reside in the same user, and conclude that all of J modified copies ITEM-2 256₂ are indeed modified and thus unusable. Download-infringing user 202 can refrain from downloading any of these J modified copies of ITEM-2 256₂, and instead download infringing (usable) ITEM-2 118₂ from share-infringing user 112. Thus, when download-infringing user 202 employs the ping command in selecting an item, she may be able to differentiate an infringing copy from a modified one and hence increase the probability for downloading a usable item. It is noted that searching server 100 (FIG. 1), production server 150 (FIG. 2) and item sharing server 250 (FIG. 4A), or a combination thereof, can be integrated in one unit.

Reference is now made to FIG. 4B, which is a schematic illustration of an item sharing server, generally referenced 300, constructed and operative in accordance with a further preferred embodiment of the present invention. Item sharing server 300 includes a plurality of virtual users 302₁, 302₂ and 302_{L}, a plurality of fixed delay units 304₁, 304₂ and 304_{L} and a storage unit 306. Storage unit 306 includes a plurality of different modified items, such as ITEM-1 308₁, ITEM-2 308₂ and ITEM-P 308_{P} (P is not necessarily equal to N in ITEM-N 118_{N}).

Fixed delay unit 304₁ is coupled to network 116 and to virtual user 302₁. Fixed delay unit 304₂ is coupled to network 116 and to virtual user 302₂. Fixed delay unit 304_{L} is coupled to network 116 and to virtual user 302_{L}. Virtual users 302₁, 302₂ and 302_{L} are coupled to storage unit 306. Download-infringing users 202, 204, share-infringing user 112 and directory 114 are coupled to network 116.

Each of fixed delay units 304₁, 304₂ and 304_{L} is a unit which responds to a ping command with a delay. The delay of each of fixed delay units 304₁, 304₂ and 304_{L} is constant, but different from the rest. For example, the delay of each of fixed delay units 304₁, 304₂ and 304_{L} is 45 ms, 10 ms and 145 ms, respectively. When download-infringing user 204 initiates a ping command to virtual user 302₁, fixed delay unit 304₁ applies a delay of 45 ms and virtual user 302, sends back an ACK₁ signal to download-infringing user 204, after a delay of 45 ms. When download-infringing user 204 initiates a ping command to virtual user 3022, fixed delay unit 304₂ applies a delay of 10 ms and virtual user 302₂ sends back an ACK₂ signal to download-infringing user 204, after a delay of 10 ms. When download-infringing user 204 initiates a ping command to virtual user 302_{L}, fixed delay unit 304_{L} applies a delay of 145 ms and virtual user 302_{L} sends back an ACK_{L} signal to download-infringing user 204, after a delay of 145 ms.

Share-infringing user 112 is located at a location substantially different than item sharing server 300, relative to download-infringing user 204. The ping of share-infringing user 112 is for example, 350 ms.

When download-infringing user 204 searches for ITEM-2 (not shown), the search result provided by directory 114 indicates that one ITEM-2 118₂ (which is usable), resides in share-infringing user 112 and L copies of ITEM-2 308₂, reside in each of virtual users 302₁, 302₂ and 302_{L}. The characteristics listed in the search result for ITEM-2 118₂ are identical with the characteristics listed for each of the L copies of ITEM-2 308₂.

The downloading application running in download-infringing user 204 indicates a ping of 295 ms for modified ITEM-2 308₂ of virtual user 302₁, a ping of 260 ms for modified ITEM-2 308₂ of virtual user 302₂, a ping of 395 ms for modified ITEM-2 308₂ of virtual user 302_{L} and a ping of 350 ms for infringing ITEM-2 118₂ of share-infringing user 112. By comparing the pings of virtual users 302₁, 302₂ and 302_{L} and share-infringing user 112, download-infringing user 204 concludes that virtual users 302₁, 302₂ and 302_{L} and share-infringing user 112 are all different users physically located at different locations and also that the L copies of modified ITEM-2 308₂ are supposedly usable. In this case, the probability that download-infringing user 204 downloads infringing (usable) ITEM-2 118₂ in the first try, is n/(n+L), where n denotes the number of infringing copies of ITEM-2. The greater the number of virtual users 302₁, 302₂ and 302_{L}, the lower the probability that download-infringing user 204 downloads the infringing (usable) ITEM-2 118₂ in the first try.

Download-infringing user 204 can identify virtual users 302₁, 302₂ and 302_{L} as such, by analyzing the search result and determining that each of virtual users 302₁, 302₂ and 302_{L} points to the same plurality of items (i.e., ITEM-1 308₁, ITEM-2 308₂ and ITEM-P 308_{P}). To circumvent this problem, each of virtual users 302₁, 302₂ and 302_{L} can share a different set of the modified items stored in storage unit 306. For example, virtual user 302₁ shares ITEM-1 308₁, ITEM-3 (not shown) and ITEM-4 (not shown), virtual user 302₂ shares ITEM-2 308₂, ITEM-9 (not shown), ITEM-11 (not shown) and ITEM-15 (not shown) and virtual user 302_{L} shares ITEM-20 (not shown), ITEM-29 (not shown) and ITEM-P 308_{P}.

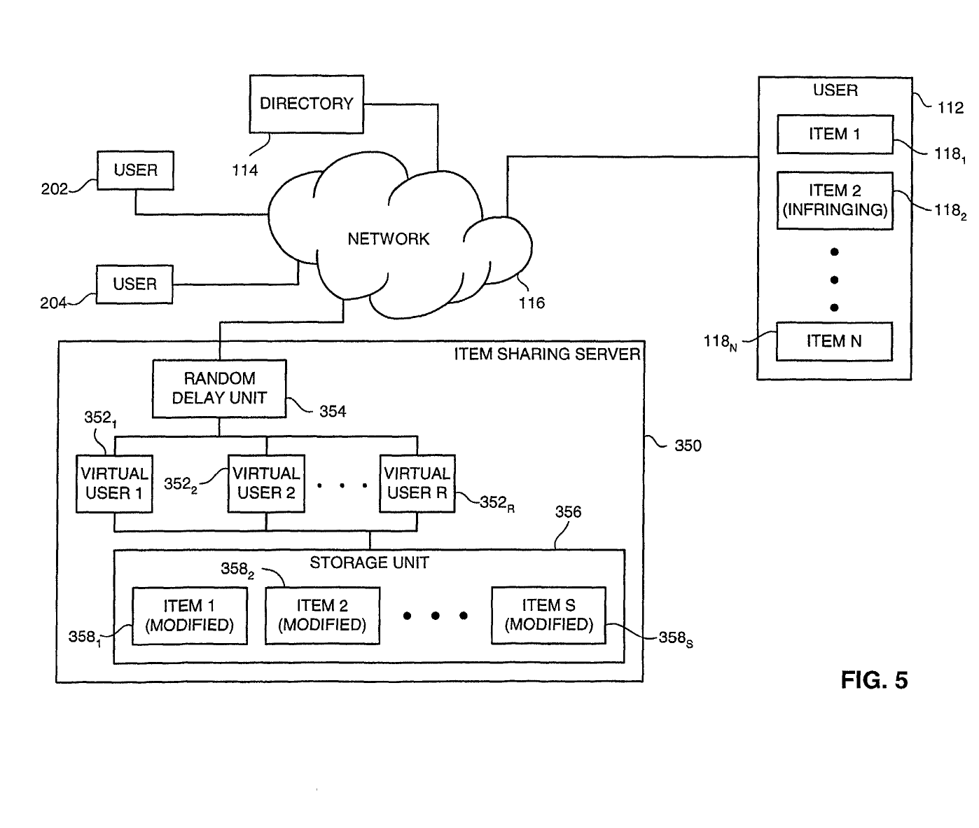

Reference is now made to FIG. 5, which is a schematic illustration of an item sharing server, generally referenced 350, constructed and operative in accordance with another preferred embodiment of the present invention. Item sharing server 350 includes a plurality of virtual users 352₁, 352₂ and 352_{R}, a random delay unit 354 and a storage unit 356. Storage unit 356 includes a plurality of different modified items, such as ITEM-1 358₁, ITEM-2 358₂ and ITEM-S 358_{S} (S is not necessarily equal to N in ITEM-N 118_{N}).

Random delay unit 354 is coupled to network 116 and to virtual users 352₁, 352₂ and 352_{R}. Virtual users 352₁, 352₂ and 352_{R}, are coupled to storage unit 356. Download-infringing users 202, 204, share-infringing user 112 and directory 114 are coupled to network 116. Random delay unit 354 selects a time delay, randomly.

When download-infringing user 202 searches for ITEM-2 (not shown), the search result provided by directory 114 indicates that one ITEM-2 118₂, resides in share-infringing user 112 and R copies of ITEM-2 358₂, reside in each of virtual users 352₁, 352₂ and 352_{R}. Download-infringing user 204, then initiates ping commands to share-infringing user 112, and to virtual users 352₁, 352₂ and 352_{R}.

For example, when download-infringing user 202 initiates a ping command to virtual user 352₁, random delay unit 354 randomly selects a time delay of 200 ms and thus virtual user 352₁ sends back an “ACK₁” signal to download-infringing user 202 after a delay of 200 ms. When download-infringing user 202 initiates a ping command to virtual user 352₂, random delay unit 354 randomly selects a time delay of 9 ms and thus virtual user 352₂ sends back an “ACK₂” signal to download-infringing user 202 after a delay of 9 ms. When download-infringing user 202 initiates a ping command to virtual user 352_{R}, random delay unit 354 randomly selects a time delay of 55 ms and thus virtual user 352_{R} sends back an “ACK_{R}” signal to download-infringing user 202 after a delay of 55 ms.

Share-infringing user 112 is located at a location substantially different than item sharing server 350, relative to download-infringing user 202. The ping of share-infringing user 112 is for example, 500 ms. By inspecting the ping for share-infringing user 112 and the pings for virtual users 352₁, 352₂ and 352_{R}, download-infringing user 202 concludes that infringing ITEM-2 118₂ and the R modified ITEM-2's 358₂ each resides in a different user. Thus, download-infringing user 202 can not determine which of ITEM-2 118₂, and the R modified ITEM-2's 358₂ is the unmodified (usable) copy of ITEM-2.

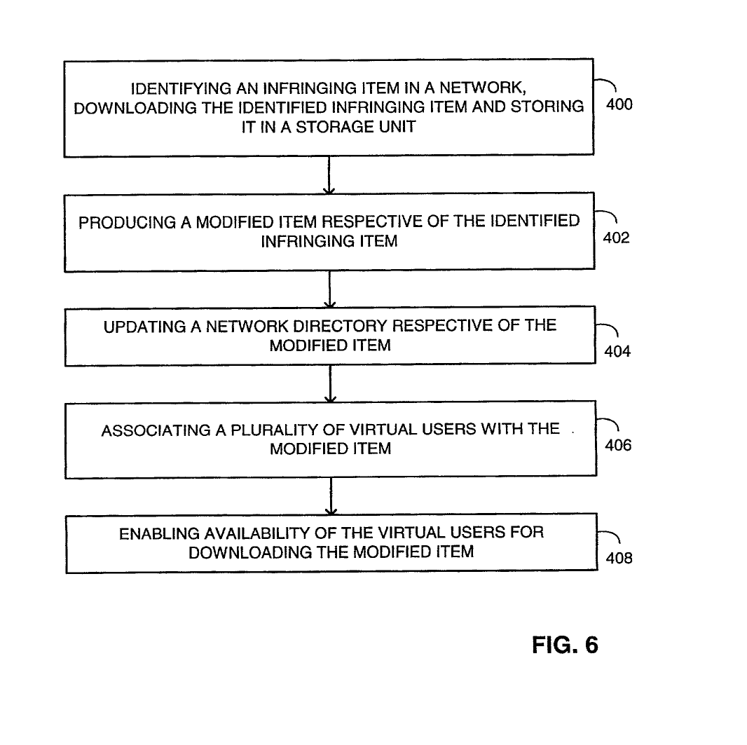

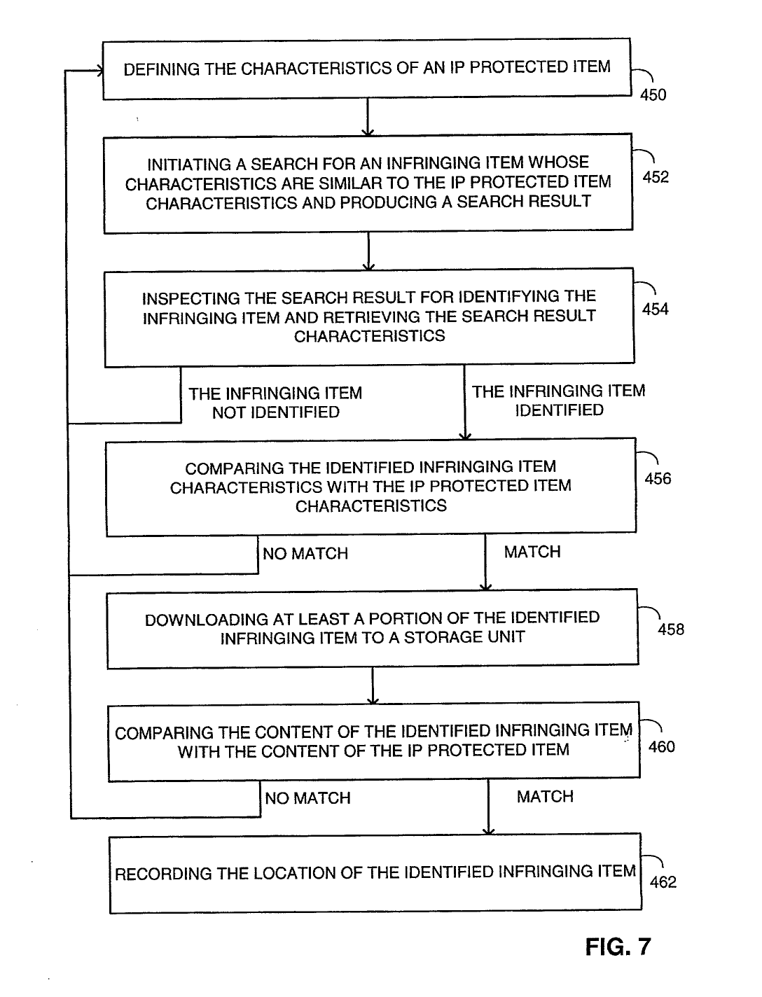

Reference is now made to FIG. 6, which is a schematic illustration of a method for proliferating unusable copies of an item in a network, operative in accordance with a further preferred embodiment of the present invention. In step 400, an infringing item in a network is identified, the infringing item is downloaded and stored in a storage unit. With reference to FIG. 1, sniffing user 102 searches network 116 for infringing ITEM-2 118₂. Directory 114 provides sniffing user 102 with a search result which includes ITEM-2 118₂, sniffing user 102 identifies ITEM-2 118₂ as the infringing item, and determines that infringing ITEM-2 118₂ resides in share-infringing user 112. Sniffing user 102 downloads infringing ITEM-2 118₂ from share-infringing user 112 and stores infringing ITEM-2 118₂ in a storage unit (not shown). Step 400 is described in detail herein below in conjunction with FIG. 7.

In step 402, a modified item, respective of the identified infringing item, is produced. With reference to FIG. 2, processor 156 produces modified ITEM-2 154 according to at least a portion of IP protected ITEM-2 158. Alternatively, processor 156 produces modified ITEM-2 154 according to at least a portion of infringing ITEM-2 118₂. Processor 156 produces modified ITEM-2 154, such that the characteristics thereof (e.g., title, file size and production date) are substantially identical with the characteristics of infringing ITEM-2 118₂. However, processor 156 produces modified ITEM-2 154 in such a manner that modified ITEM-2 154 can not be used the way infringing ITEM-2 118₂ or IP protected ITEM-2 158 is generally used in its entirety. For example, modified ITEM-2 154 can contain the same content as of IP protected ITEM-2 158, while selected segments of the content are located out of sequence.

A user which receives the characteristics of modified ITEM-2 154 in a search result, can not determine that modified ITEM-2 154 is indeed modified and useless, by inspecting the characteristics thereof, alone. Neither after downloading modified ITEM-2 154 (which demands substantial resources such as computer time, bandwidth fees, and the like), can the user determine that modified ITEM-2 154 is useless. When the modified item is a media item (video, audio or readable files such as e-books), only after starting to use a considerable portion of modified ITEM-2 154 does the user determine that modified ITEM-2 154 is useless.

In step 404, a network directory is updated, respective of the modified item. With reference to FIG. 2, production server 150 updates directory 114 by reporting to directory 114 the characteristics of modified ITEM-2 154 and the URL, network protocol address, user name, MAC address, and the like, of virtual user 152.

In step 406, a plurality of virtual users are associated with the modified item. With reference to FIG. 4B, item sharing server 300 provides association between virtual users 302₁, 302₂ and 302_{L}, and modified ITEM-2 308₂ by storing modified ITEM-2 308₂ in storage unit 306. An outcome of this association is that in a list included in directory 114, when virtual users 302₁, 302₂ and 302_{L} are coupled to network 116, modified ITEM-2 308₂ (including the characteristics thereof points to each of virtual users 302₁, 302₂ and 302_{L}. Moreover, modified copies of other items such as modified ITEM-1 308₁ and modified ITEM-P 308ₚ are associated with each of virtual users 302₁, 302₂ and 302_{L}.

In step 408, the availability of the virtual users for downloading the modified item, is enabled. With reference to FIG. 4B, item sharing server 300 couples each of virtual users 302₁, 302₂ and 302_{L} to network 116. Thus, other users connected to network 116, such as download-infringing users 202, 204 and share-infringing user 112, can download modified ITEM-2 308₂ and other modified items such as modified ITEM-1 308₁ and modified ITEM-P 308_{P}.

Reference is now made to FIG. 7, which is a schematic illustration of step 400 of FIG. 6, operative in accordance with another preferred embodiment of the present invention. In step 450, the characteristics of an IP protected item are defined. With reference to FIG. 1, sniffing user 102 retrieves at least one of the characteristics (e.g., title, creation date, file size, and the like) of an IP protected item, from characteristics database 104.

In step 452, a search is initiated for an infringing item whose characteristics are similar to the IP protected item characteristics and a search result is produced according to the search. With reference to FIG. 1, sniffing user 102 searches network 116 for infringing ITEM-2 118₂ whose characteristics are similar to the characteristics of the IP protected item, which were defined in step 450. It is noted that directory 114 can identify more than one infringing item whose characteristics are similar to the IP protected item characteristics.

For example, if sniffing user 102 provides directory 114 with the title of an IP protected item, such as “Donald Duck”, then the search result can include the items with the similar titles “Donald Duck at Sea”, “Donald Duck in Jail” and “Donald Duck in Africa” as the putative infringing items. In this case, with reference to FIG. 1, “Donald Duck at Sea” is ITEM-1 118₁, “Donald Duck in Jail” is infringing ITEM-2 118₂ and “Donald Duck in Africa” is ITEM-N 118_{N}.

In step 454, the search result is inspected for identifying the infringing item and the characteristics listed in the search result, are retrieved. With reference to FIG. 1, sniffing user 102 inspects the search result. The search result includes the characteristics of infringing ITEM-2 118₂, such as the title (i.e., “Donald Duck in Jail”), the producer (i.e., “Walt Disney Productions”), and the type (i.e., “Video”). Sniffing user 102 retrieves the characteristics listed in the search result, for identifying the infringing item, by referring for example, to characteristics database 104. Sniffing user 102 determines that share-infringing user 112 owns a license to use ITEM-1 118₁ and ITEM-N 118_{N}, but owns no license for using ITEM-2 118₂. Thus, sniffing user 102 determines that ITEM-2 118₂ is an infringing copy of ITEM-2 (i.e., “Donald Duck in Jail”) and the method proceeds to step 456. If sniffing user 102 identifies no infringing items in the search result, then the method returns back to step 450, for defining the characteristics for a new IP protected item.

In step 456, the identified infringing item characteristics are compared with the IP protected item characteristics. With reference to FIG. 1, sniffing user 102 compares the characteristics of ITEM-2 118₂, with the characteristics of IP protected ITEM-2. The characteristics of ITEM-2 118₂ were retrieved from the search result in step 454 and the characteristics of IP protected ITEM-2 are retrieved from characteristics database 104. If the two characteristics do not match, then the method returns back to step 450, for defining the characteristics for a new IP protected item.

If these two characteristics match, then the method can end the detection phase or proceed to step 458, which increases the identification certainty. In step 458, at least a portion of the identified infringing item is downloaded to a storage unit. With reference to FIG. 1, sniffing user 102 downloads at least a portion of infringing ITEM-2 118₂ to a storage unit (not shown) located in searching server 100. Sniffing user 102, then stores the identified infringing item characteristics in a storage unit and records the location (i.e., the URL, network protocol address, user name, MAC address, and the like of share-infringing user 112) of ITEM-2 118₂, in the storage unit (step 462).

In step 460, the content of the identified infringing item, is compared with the content of the IP protected item. Many methods for comparing media content can be used for this step. In the example set forth in FIG. 1, sniffing user 102 produces a content based signature for at least a portion of the downloaded content of infringing ITEM-2 118₂, and retrieves the signature of ITEM-2 (i.e., “Donald Duck in Jail”), from signature database 106. Sniffing user 102, then compares the produced signature with the retrieved signature. If the signature of the IP protected ITEM-2, and the signature of infringing ITEM-2 118₂ do not match, then the method returns back to step 450, for defining the characteristics for a new IP protected item. If the signature of the IP protected ITEM-2, and the signature of infringing ITEM-2 118₂ match, then the method proceeds to step 460.

It is noted that steps 458 and 460 merely provides confirmation that the content of the identified infringing item is indeed infringing. Hence, when a low level of certainty is required, steps 458 and 460 can be discarded, whereby an infringing item is identified merely according to immediate characteristics such as item title, item size and item type.

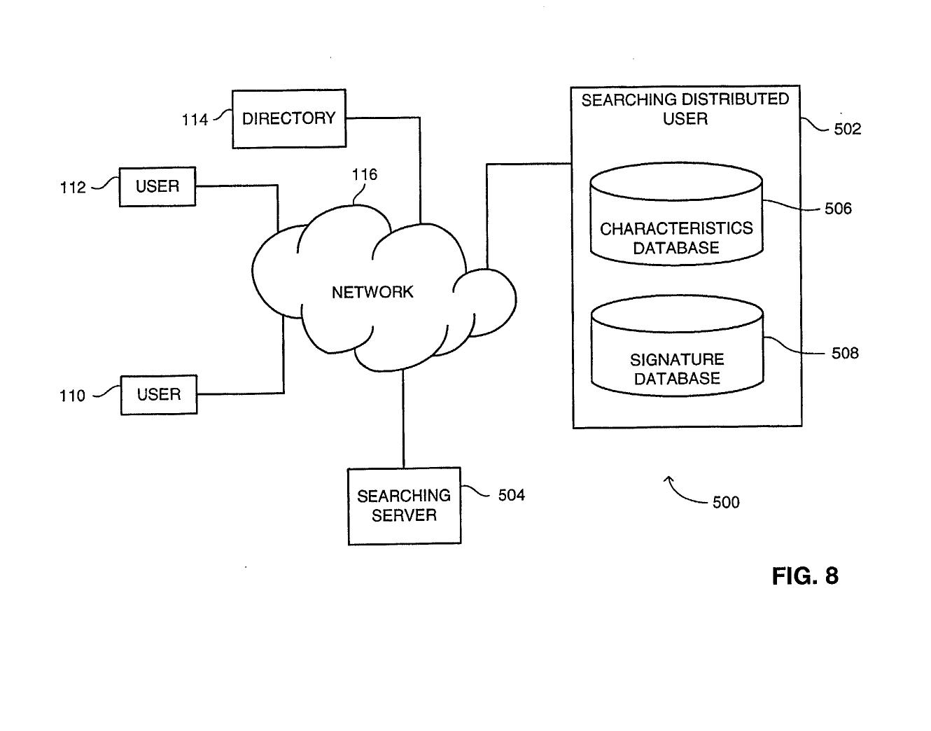

Reference is now made to FIG. 8, which is a schematic illustration of a computer system, generally referenced 500, constructed and operative in accordance with a further preferred embodiment of the present invention. System 500 includes a searching distributed user 502 and a searching server 504. Searching distributed user includes a characteristics database 506 and a signature database 508.

Searching distributed user is a workstation, desktop, laptop, mobile unit, network user applications, and the like. Searching server 504, characteristics database 506 and signature database 508 are similar to searching server 100 (FIG. 1), characteristics database 104 and signature database 106, respectively. Characteristics database 506 and signature database 508 include the characteristics and the signatures, respectively, of selected IP protected items (not shown). Searching distributed user 502, searching server 504, user 110, share-infringing user 112 and directory 114 are coupled to network 116.

Searching server 504 uploads characteristics database 506 and signature database 508 to searching distributed user 502, via network 116. Alternatively, searching server 504 delivers a hard copy of characteristics database 506 and signature database 508 to searching distributed user 502, in the from of CD-ROM, floppy disk, flash memory, and the like.

Searching distributed user 502 searches network 116 for an infringing copy of a selected IP protected item, for example ITEM-2 (not shown), according to the characteristics thereof. According to a search result which searching distributed user 502 receives from directory 114, infringing ITEM-2 118₂ (FIG. 1) resides in share-infringing user 112. Searching distributed user 502 downloads at least a portion of infringing ITEM-2 118₂ and produces a signature for infringing ITEM-2 118₂ according to downloaded infringing ITEM-2 118₂. Searching distributed user 502 retrieves the signature of IP protected ITEM-2 from signature database 508 and compares this signature with the produced signature of infringing ITEM-2 118₂. If the two signatures match, then searching distributed user 502 uploads the characteristics of infringing ITEM-2 118₂ to searching server 504, via network 116. Searching server 504 offers searching distributed user 502, to download an IP protected item and a license to use the IP protected item, from searching server 504, as a reward for the search which searching distributed user 502 performs. Additionally, searching server 504 offers searching distributed user 502, to download a screen saver from searching server 504. Further additionally, searching server 504 offers searching distributed user 502, movie tickets, a financial incentive, and the like.

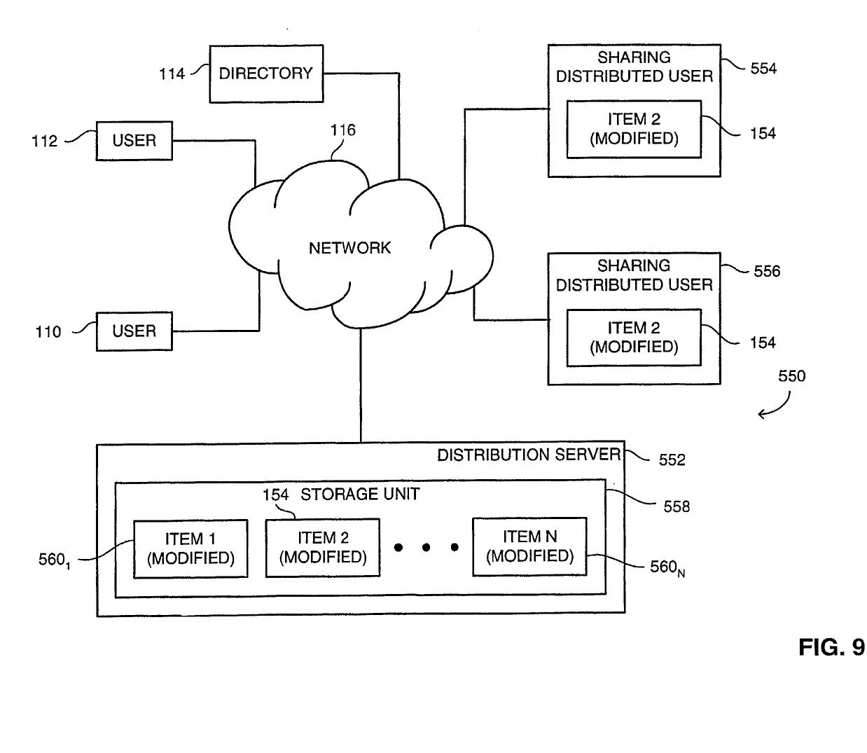

Reference is now made to FIG. 9, which is a schematic illustration of a computer system, generally referenced 550, constructed and operative in accordance with another preferred embodiment of the present invention. System 550 includes a distribution server 552 and sharing distributed users 554 and 556. Distribution server 552 includes a storage unit 558. Storage unit 558 includes a plurality of modified items, such as modified ITEM-1 560₁, modified ITEM-2 154 and modified ITEM-N 560_{N}. Modified ITEM-2 154 is a modified copy of infringing ITEM-2 118₂ (FIG. 1). Alternatively, modified ITEM-2 154 is a modified copy of IP protected ITEM-2 158 (FIG. 2). Modified ITEM-2 154 is previously produced by production server 150 (FIG. 2). The size of modified ITEM-2 154 is substantially equal to the size of infringing ITEM-2 118₂. Sharing distributed users 554 and 556 are located at substantially different physical locations.

Each of sharing distributed users 554 and 556 is a workstation, desktop, laptop, mobile unit, network user applications, and the like. Sharing distributed users 554 and 556, distribution server 552, user 110, share-infringing user 112 and directory 114 are coupled to network 116.

Distribution server 552 uploads modified ITEM-2 154 to sharing distributed users 554 and 556, via network 116. Alternatively, distribution server 552 uploads modified ITEM-2 154 to sharing distributed users 554 and 556, during an idle period (i.e., when the communication load in network 116 is low and the cost of bandwidth is low). Further alternatively, distribution server 552 uploads to sharing distributed users 554 and 556, a portion of the beginning of infringing ITEM-2 118₂, and a supplementary material. Each of sharing distributed users 554 and 556, then produces a combined modified item (not shown) for infringing ITEM-2 118₂, by combining the beginning portion of ITEM-2 with a plurality of the supplementary material, so that the size of the combined modified item is substantially equal to infringing ITEM-2 118₂. Each of sharing distributed users 554 and 556, then stores the combined modified item in a storage unit therein.

It is noted that the beginning portion of ITEM-2 and the supplementary material, are each in a format which allows a supplementary material to be linked to the beginning portion and each supplementary material to be linked to the previous supplementary material. Thus, the combined modified item is in a format known in the art, such as MIDI, WAV, AVI, MPEG, JPEG, ASCII, TIFF, GIF, PDF, RTF, bitmap, and the like, and the combined modified item can be downloaded from one user to another, connected to a network.

For example, the size of ITEM-2 118₂ is 600 MB, the size of the beginning portion of ITEM-2 is 30 MB and the size of the supplementary material is 5 MB. The combined modified item, then includes the beginning portion of ITEM-2 118₂ (30 MB), while the remainder 570 MB thereof (600−30=570), includes the supplementary material recurring 114 (570/5=114) times. In this case, distribution server 552 uploads only 35 MB for each of sharing distributed users 554 and 556 to produce the combined modified item, instead of uploading modified ITEM-2 154 whose size is 600 MB (i.e., the size of infringing ITEM-2 118₂).

Alternatively, distribution server 552 uploads to each of sharing distributed users 554 and 556, a plurality of different segments of infringing ITEM-2 118₂, for example, each segment having a size of 40 MB. Distribution server 552, uploads to each of sharing distributed servers 554 and 556, four segments of infringing ITEM-2 118₂ (a total of 160 MB), instead of uploading the entire modified ITEM-2 154, whose size is for example, 600 MB. In this case, each of sharing distributed users 554 and 556, produces an out-of-sequence modified item (not shown), by repetitively combining the four segments out-of-sequence, such that the size of the out-of-sequence modified item is substantially equal to the size of infringing ITEM-2 118₂. Each of sharing distributed users 554 and 556, then stores the out-of-sequence modified item in a storage unit therein.

It is noted that each of the different segments of infringing ITEM-2 118₂ is in a format which allows one segment to be linked to the previous segment. Thus, the out-of-sequence modified item is in a format known in the art, such as MIDI, WAV, AVI, MPEG, JPEG, ASCII, TIFF, GIF, PDF, RTF, bitmap, and the like, and the out-of-sequence modified item can be downloaded from one user to another, connected to a network.

When user 110 initiates a search for ITEM-2 118₂ (FIG. 1) in network 116, directory 114 provides user 110 with a search result. The search result indicates that a copy of ITEM-2 118₂ resides in share-infringing user 112, a copy of ITEM-2 154 resides in sharing distributed user 554 and another copy of ITEM-2, referenced 154 resides in sharing distributed user 556.

Since the characteristics of ITEM-2 1182 and the two ITEM-2's 154 are identical, user 110 can not determine that the two copies of ITEM-2 154 are modified and thus unusable. Furthermore, since the physical locations of share-infringing user 112 and sharing distributed users 554 and 556 are different, the pings of these users are different. Thus, user 110 can not determine which of ITEM-2's 118₂ and 154 are modified and unusable, by examining the characteristics and pings thereof, alone.

When user 110 transmits a request for example, to sharing distributed user 554 to download modified ITEM-2 154 therefrom, then sharing distributed user 554 uploads to user 110 modified ITEM-2 154, which distribution server 552 had previously uploaded to sharing distributed user 554. Alternatively, sharing distributed user 554 uploads to user 110 the combined modified item, from the storage unit therein. Further alternatively, sharing distributed user 554 uploads to user 110 the out-of-sequence modified item, from the storage unit therein.

Alternatively, sharing distributed user 554 uploads to user 110 the beginning portion of infringing ITEM-2 118₂ and then a selected number of the supplementary material, such that the amount of uploaded data is substantially equal to the size of infringing ITEM-2 118₂. Alternatively, sharing distributed user 554 uploads to user 110 a selected number of the different segments of infringing ITEM-2 118₂, out-of-sequence, such that the amount of uploaded data is substantially equal to the size of infringing ITEM-2 118₂.

Further alternatively, sharing distributed user 554 uploads the different segments of infringing ITEM-2 118₂, out-of-sequence, for as long as user 110 is connected to sharing distributed user 554 via network 116 and for as long as the downloading application is running in both user 110 and sharing distributed user 554. Alternatively, when user 110 opens infringing ITEM-2 118₂, infringing ITEM-2 118₂ runs properly during the beginning portion thereof, but ceases to run thereafter, or runs improperly thereafter.

Further alternatively, when sharing distributed user 554 uploads modified ITEM-2 154 to user 110, sharing distributed user 554 determines the e-mail address of user 110 according to the user name thereof. Sharing distributed user 554 then sends an e-mail message to user 110. In this e-mail message, sharing distributed user 554 notifies user 110 that it has infringed IP protected rights, reports the means by which user 110 can obtain a legitimate of infringing ITEM-2 118₂, posts an advertisement, a commercial promotion, and the like.

According to another aspect of the present invention, other sharing distributed users (not shown), can be connected to each of sharing distributed users 554 and 556, via Internet Protocol (IP) multicasting. Each of sharing distributed users 554 and 556 uploads modified ITEM-2 154 to each of these other sharing distributed users connected thereto. Thus, the number of the sharing distributed users which include modified ITEM-2 154 can be increased considerably, at a relatively low bandwidth cost. Furthermore, periodically, for example once a year, distributed server 552 deletes those modified items from each of sharing distributed users 554 and 556, which are no longer being downloaded with sufficient frequency, by user 110 or share-infringing user 112.

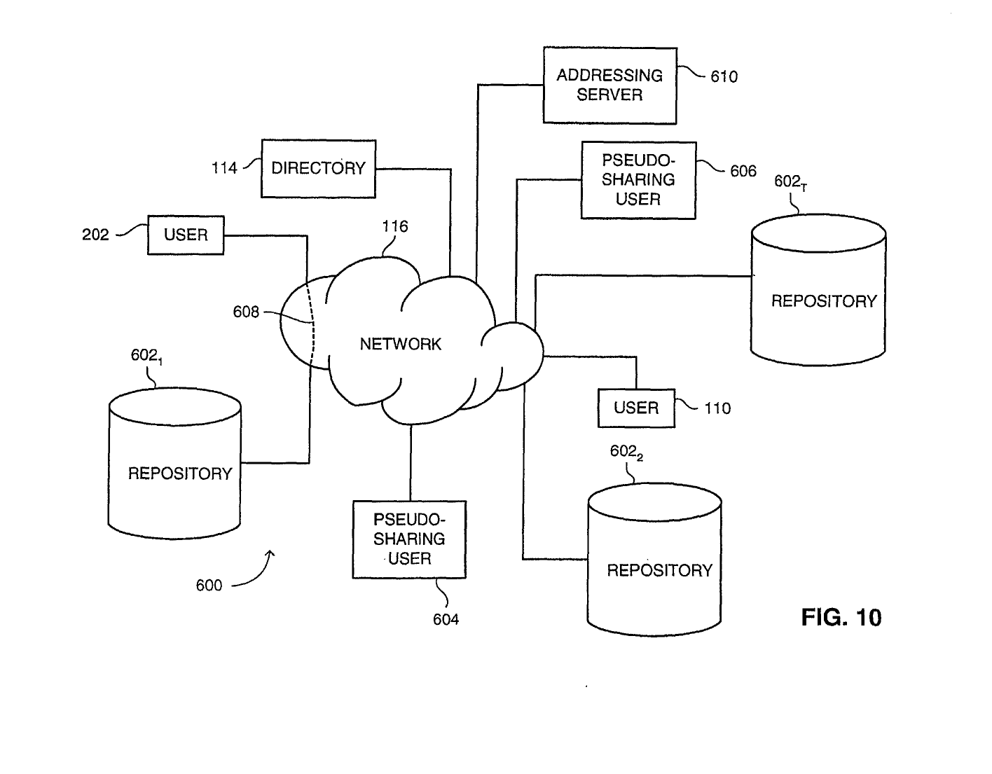

Reference is now made to FIG. 10, which is a schematic illustration of a computer system, generally referenced 600, constructed and operative in accordance with a further preferred embodiment of the present invention. System 600 includes a plurality of repositories 602₁, 602₂ and 602_{T}, an addressing server 610 and a plurality of pseudo-sharing users 604 and 606. Repositories 6021, 6022 and 602T, pseudo-sharing users 604 and 606, addressing server 610, user 110, download-infringing user 202 and directory 114 are connected to network 116. It is noted that repositories 602₁, 602₂ and 602_{T} include internal network interfaces (not shown) for coupling to network 116.

The term “peer brokering” herein below, refers to a method by which a first user connected to a network, provides connection between a second user and a third user via the network, when the second user connects to the first user. The first user, then tears down its connection with the second user, and instead connects the second user with the third user. The second user perceives that it is communicating with the first user, while the second user is actually communicating with the third user.

Each of pseudo-sharing users 604 and 606 is a workstation, desktop, laptop, mobile unit, network user applications, and the like. Each of pseudo-sharing users 604 and 606 includes a peer brokering function. Each of pseudo-sharing users 604 and 606 includes a list of modified items (not shown). Each of repositories 602₁, 602₂ and 602_{T}, includes the content of all or a portion of the modified items listed in each of pseudo-sharing users 604 and 606. Addressing server 610 includes a characteristics list of all the modified items which are located in repositories 602₁, 602₂ and 602_{T}. Each entry in the characteristics list includes a pointer to the specific location in the repository which includes the content of the modified item recorded in the entry.

When download-infringing user 202 searches for a selected item in network 116, directory 114 provides download-infringing user 202 with a search result. The modified items list of pseudo-sharing user 604 includes the selected item. Therefore, the search result indicates that the selected item resides in pseudo-sharing user 604. By running the downloading application, download-infringing user 202 establishes connection with pseudo-sharing user 604 and initiates a request to download the selected item from pseudo-sharing user 604.

The following is a peer brokering scenario according to another aspect of the invention. Download-infringing user 202 transmits a request message to pseudo-sharing user 604 to download an item. In return, pseudo-sharing user 604 directs download-infringing user 202 to one of repositories 602₁, 602₂ and 602_{T}, for downloading the requested item therefrom. It is noted that this directing procedure is seamless to download-infringing user 202.

Pseudo-sharing user 604 transmits a peer brokering message to addressing server 610 and tears down its connection with download-infringing user 202. This peer brokering message includes the network address of download-infringing user 202 and the characteristics of the requested item. According to the characteristics list, addressing server 610 determines that a modified copy of the requested item is located for example, in repository 602₁. Addressing server 610 transmits a message to download-infringing user 202 to establish connection with repository 602₁ (e.g., via a link 608) and another message to repository 602₁, to respond to download-infringing user 202. Furthermore, addressing server 610 instructs repository 602₁ to upload the modified version of the requested item to download-infringing user 202. Download-infringing user 202 downloads the modified version of the requested item from repository 602₁, but download-infringing user 202 perceives that it is downloading the modified item from pseudo-sharing user 604. In this manner, pseudo-sharing users 604 and 606 operate as “agents” on behalf of repositories 602₁, 602₂ and 602_{T}, while consuming substantially small computer resources, such as bandwidth and memory.

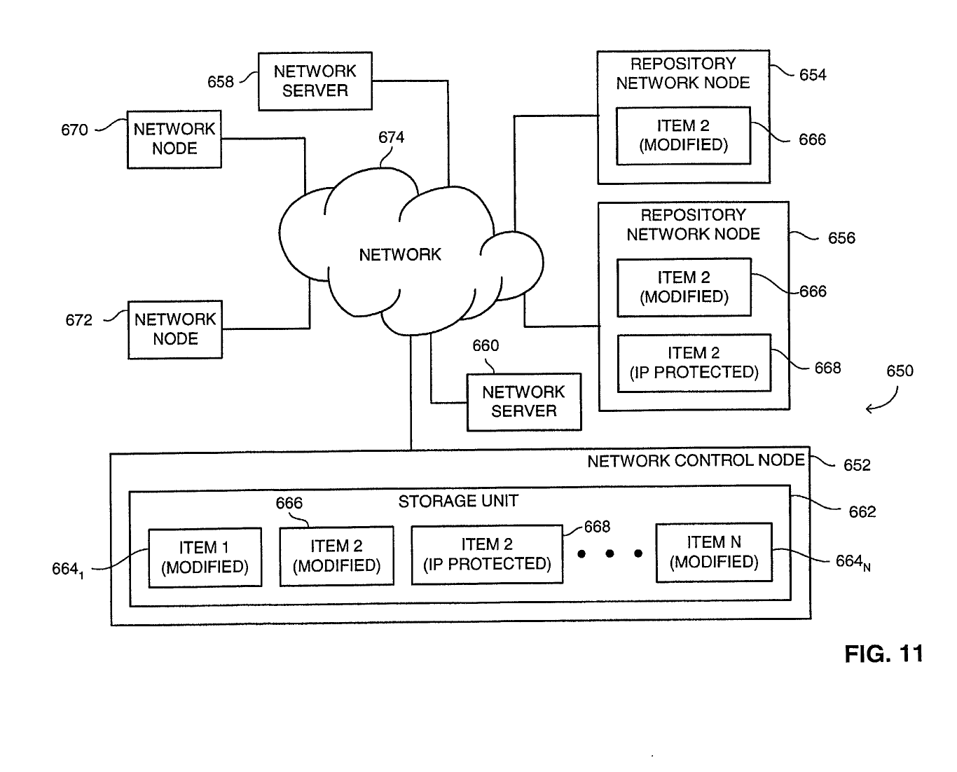

Reference is now made to FIG. 11, which is a schematic illustration of a computer system, generally referenced 650, constructed and operative in accordance with another preferred embodiment of the present invention. System 650 includes a network control node 652, repository network nodes 654 and 656 and a plurality of network servers 658 and 660. Network control node 652 includes a storage unit 662. Storage unit 662 includes a plurality of modified items and a plurality of IP protected items such as modified ITEM-1 664₁, modified ITEM-2 666, modified ITEM-N 664_{N} and IP protected ITEM-2 668. Modified ITEM-2 666 is a modified copy of an infringing ITEM-2 (not shown). Alternatively, modified ITEM-2 666 is a modified copy of an IP protected ITEM-2 (not shown). Modified ITEM-2 666 is previously produced by a production server, such as production server 150 (FIG. 2).

Repository network nodes 654 and 656, network control node 652 and network 674 are similar to sharing distributed users 554 and 556, distribution server 552 and network 116 (FIG. 9), respectively. Repository network nodes 654 and 656 belong to a group of repository network nodes (not shown), which are controlled by network control node 652. Network nodes 670 and 672 are workstations, desktops, laptops, mobile units, network user applications, and the like. Each of network servers 658 and 660 is either a central server, a search engine, or a distributed server, spreading over a plurality of nodes in network 674.

Repository network nodes 654 and 656, network control node 652, network nodes 670 and 672, and network servers 658 and 660 are coupled to network 674. Each of network servers 658 and 660 includes a logged-on list which further includes the network protocol addresses of the most recent network nodes, which were logged-on to network 674. For example, the logged-on list in each of network servers 658 and 660 includes the network protocol addresses of the top ten network nodes, which were logged-on to network 674. If network node 672 and repository network node 654, are among the top ten which were logged-on to network 674, then the logged-on list includes the network protocol addresses of network node 672 and repository network node 654.

Network control node 652 includes a shared-items directory (not shown). The shared-items directory includes a plurality of modified items and a plurality of IP protected items, such as modified ITEM-1 664₁, modified ITEM-2 666, modified ITEM-N 664_{N} and IP protected ITEM-2 668. The shared-items directory, furthermore includes an item characteristics list of the modified items and the IP protected items.

Following is a description of a scenario in which a network node searches an item in the network, locates the item in another network node and downloads the item. Network node 670 determines to locate an item in network 674. Network node 670 queries network server 658 for those network nodes which were most recently logged-on to network 674, by sending a logged-on query to network server 658. Network server 658 responds to the logged-on query by sending the logged-on list to network node 670. In a distributed network, the logged-on list includes the network protocol addresses of those network nodes which had sent a network notification command and an item query to network 674, most recently. The logged-on list further includes at least one network node port number corresponding to each network protocol address. Repository network node 654 is among the recent network nodes (i.e., among the top ten network nodes), which had sent a network notification command (e.g., a ping command) and an item query to network 674. Thus, the network protocol address of repository network node 654 is included in the logged-on list.

Network node 670 queries repository network node 654 for the item, by sending an item query to repository network node 654. Repository network node 654 compares the characteristics of the queried item, with the entries in the item characteristics list of the shared-items directory.

If the characteristics of the queried item match an entry in the item characteristics list, then repository network node 654 determines that the requested item is an IP protected item, such as ITEM-2. In this case, repository network node 654, then forwards the item query to other repository network nodes in the group. Each of these other repository network nodes in turn forwards the item query to other repository network nodes in the group, and so on. Thus, repository network node 654 forwards the item query respective of ITEM-2, to repository network node 656 and repository network node 656, in turn, forwards the item query to another repository network node (not shown).

Each of repository network nodes 654 and 656 and other repository network nodes in the group, in which modified ITEM-2 666 resides, sends an item query response to network node 670. The downloading application running in network node 670 displays a query result which includes the network protocol addresses of those network nodes which send item query responses to network node 670. In this case the query result mostly includes the network protocol addresses of repository network nodes 654 and 656, and other repository network nodes in the group, in which modified ITEM-2 666 resides.

Network node 670 selects a repository network node, such as repository network node 654 in the query result and sends an upload request to repository network node 654 to upload the queried item to network node 670. Repository network node 654 uploads modified ITEM-2 666 to network node 670. Network 674 includes a plurality of sub-networks, wherein the network nodes in each sub-network communicate with one another, in a different layer. These network nodes communicate with network nodes located in another sub-network, in another layer.

If the characteristics of the queried item does not match any entry in the item characteristics list, then repository network node 654 determines that the queried item is not an IP protected item. In this case, repository network node 654 sends the item query to other network nodes which are not repository network nodes and which are coupled to network 674, such as network node 672. Network node 672, sends an item query response to network node 670. Network node 670 can send an upload request to network node 672, to upload the queried item (which is not IP protected), to network node 670. As a result, the item query is distributed to a large number of network nodes and most of the item query responses in a case where the required item is not IP protected, are received from nodes which are not included in the group. Hence, the nodes of the group focus on handling IP protected item proliferation activity.

A network node is identified according to the network protocol address (e.g., an IP address in TCP/IP) and further in some networks such as TCP/IP, according to a port number. Thus, any network node can establish connection with another network node within the network, by designating the respective network protocol address and the respective predetermined port on that other network node. Accordingly, a plurality of network nodes can reside within the same network address, having different port numbers.

Repository network node 654, emulating a plurality of network nodes, sends a ping command and an item query for each of the emulated network nodes. Repository network node 654 assigns a different port number for each of the emulated network nodes. Each of the ping commands incorporates the network protocol address of repository network node 654 and the port number, respective of the emulated network node. Hence, the network server 658 receives a plurality of ping commands, each having a different combination of network protocol address and port number.

When network node 670 sends a logged-on query to network server 658, network node 670 receives the combinations of the network protocol addresses and the port numbers, each representing a different emulated network node. Network node 670, then sends an item query to each of these emulated network nodes.

The supplementary material in modified ITEM-2 666 which network node 670 downloads from repository network node 654, is a notice for network node 670 that the downloaded modified ITEM-2 666 is an IP protected item. The supplementary material is located substantially at the beginning portion of modified ITEM-2 666 (e.g., after the first five minutes of running downloaded modified ITEM-2 666). The notice is in the form of text, graphics, animation, voice, and the like.

Alternatively, the supplementary material in modified ITEM-2 666 which network node 670 downloads from repository network node 654, is a purchase offer for network node 670 to purchase a usable copy of modified ITEM-2 666 (i.e., to purchase IP protected ITEM-2 668). The purchase offer is in the form of text, graphics, animation, voice, and the like.

The supplementary material is located substantially at the beginning portion of modified ITEM-2 666. The beginning portion of modified ITEM-2 666 before the supplementary material (i.e., the portion of modified ITEM-2 666 before the notice and the purchase offer) is usable, whereby network node 670 continues to download modified ITEM-2 666, after examining the beginning portion of modified ITEM-2 666. For example, with a hybrid fiber-coaxial (HFC) connection to network 674, network node 670 has to allocate approximately twenty minutes to download five minutes of run-time of network node 670 (e.g., five minutes of modified ITEM-2 666). Since the beginning portion of modified ITEM-2 666 is usable, the person operating network node 670 is convinced that modified ITEM-2 666 is a genuine copy of ITEM-2 and continues to download the remaining portion of modified ITEM-2 666, after examining this beginning portion (i.e., after examining modified ITEM-2 666 for example for five minutes).

Following is a description of a scenario in which a network node, unknowingly proliferates a modified item in the network. Network node 670 initiates the downloading of modified ITEM-2 666 form repository network node 654, by sending an upload request to repository network node 654. Since the size of multimedia files is relatively large, the downloading process of this type of files generally consumes considerable time. For example, the downloading of a video title which is 2 Giga bytes, via a network connection operating at 56 kilobits per second, can take approximately 10 hours. Hence, the person who operates network node 670, can leave network node 670 unattended during the downloading process and following the completion of downloading of modified ITEM-2 666 and return to network node 670 after a considerable period of time (e.g., after forty eight hours).

When another network node, such as network node 672 sends a logged-on query to network server 658 for ITEM-2 during this unattended period, network node 672 receives a logged-on list in which the network protocol address and the port number of network node 670 is included. Network node 672 searches ITEM-2 in network node 670 and network node 672 locates modified ITEM-2 666 in network node 670. Thus, network node 670 unwittingly proliferates modified ITEM-2 666 in network 674.

Further alternatively, the supplementary material in modified ITEM-2 666, which network node 670 downloads from repository network node 654, includes at least one link to at least one network site in network 674. The network site includes a purchase offer for network node 670 to purchase IP protected ITEM-2 668 (i.e., a usable copy of modified ITEM-2 666). The purchase offer is in the form of text, graphics, animation, voice, and the like.

Alternatively, the network site includes a membership offer for network node 670 to operate as a repository network node, such as repository network nodes 654 and 656. The membership offer is in the form of text, graphics, animation, voice, and the like. Network node 670 accepts either the purchase offer or the membership offer. Alternatively, network node 670 denies either the purchase offer or the membership offer.

According to a preferred embodiment of the invention, when a person operating a network node, purchases an item from a service node, that item is provided to that network node in an encrypted format which can only be decrypted by that person by means of user sensitive information known only to that person. According to this embodiment, the user sensitive information is selected such that the user shall have little incentive to share that sensitive information with other persons, throughout the network.

The user sensitive information is an alphanumeric string which is essentially considered private respective of the person operating network node 670. The alphanumeric string is the credit card number of that person, the social security number of that person, the bank account number of that person, a word, a number, or a combination of letters and digits known only to that person, and the like.

Network node 670 sends a purchase request to a service node (not shown), to purchase IP protected ITEM-2 668. The service node is generally a trusted entity respective of handling credit card information over network 674, such as Amazon, Yahoo, and the like. The service node responds to the purchase request, by sending an ID request to network node 670, for network node 670 to provide user sensitive information thereof, to the service node.

Network node 670 sends the user sensitive information (e.g., the credit card number and credit card information, or the bank account number of the person who operates network node 670), to the service node. The service node verifies that the received user sensitive information is unique, respective of that person (e.g., the received credit card number is authentic).

The service node performs a financial transaction according to the received credit card number, received credit card information, or the bank account number. The service node determines an encryption key, by applying an encryption algorithm, such as a one-way function, and the like, to the received user sensitive information (e.g., the received credit card number or the received bank account number).

The service node encrypts IP protected ITEM-2 668, according to the determined encryption key and uploads the encrypted IP protected ITEM-2 668, to network node 670. Network node 670 decrypts the received encrypted IP protected ITEM-2 668, according to a decryption algorithm and by using the user sensitive information. The decryption algorithm can be part of the downloading application which runs in network node 670.

Network node 670 can upload IP protected ITEM-2 668 to network node 672, only in the encrypted format, as the service node had previously encrypted IP protected ITEM-2 668. According to a preferred embodiment of the invention, any use of IP protected ITEM-2 668 requires the user sensitive information and network node 670 cannot decrypt IP protected ITEM-2 668 and store it in decrypted format. Accordingly, if network node 670 uploads IP protected ITEM-2 668 to network node 672, then network node 670 has to provide the user sensitive information thereof to network node 672, otherwise IP protected ITEM-2 668 is unusable.

It is understood that the person operating network node 670 would be reluctant to provide his sensitive information to other persons over the network, such as the person operating network node 672. Thus, by encrypting IP protected ITEM-2 668 with the user sensitive information, the service node reduces the probability that network node 670 uploads IP protected ITEM-2 668 to network node 672.

According to another embodiment of the invention, the service node forwards the purchase request received from network node 670, to network control node 652 and network control node 652 handles the entire purchase request, as described herein above with respect to the service node. According to a further embodiment of the invention, network node 670 sends a purchase request to repository network node 656 to purchase IP protected ITEM-2 668. Repository network node 656 responds to the purchase request, by sending an ID request to network node 670.

The ID request includes job identification information. The job identification information includes information respective of the purchase request, such as the characteristics of IP protected ITEM-2 668, time of the purchase request, the network protocol addresses of network node 670 and of repository network node 656, and the like.

Network node 670 responds to the ID request by sending the user sensitive information together with the job identification information, to network control node 652. Network control node 652 verifies that the received user sensitive information is unique, respective of network node 670 (e.g., the received credit card number is authentic).

Network control node 652 performs a financial transaction according to the received credit card number, received credit card information, or the bank account number. Network control node 652 determines an encryption key, as described herein above with respect to the service node. Network control node 652 sends the encryption key together with the job identification information to repository network node 656. Repository network node 656 encrypts IP protected ITEM-2 668, according to the received encryption key and uploads the encrypted IP protected ITEM-2 668, to network node 670, according to the received job identification information. Alternatively, network control node 652 encrypts IP protected ITEM-2 668, according to the determined encryption key and uploads the encrypted IP protected ITEM-2 668, to network node 670. Network node 670 decrypts the received encrypted IP protected ITEM-2 668, as described herein above.

According to another preferred embodiment, the decryption algorithm is incorporated in a playback application. Accordingly, network node 670 has to provide the user sensitive information as a decryption key, each time IP protected ITEM-2 668 is executed (i.e., played back or run). According to this embodiment, neither network node 670 nor repository network node 654 can decrypt the encrypted version of IP protected ITEM-2 668 into a decrypted version. Hence, neither network node 670 nor repository network node 656 can create a file for the decrypted version of IP protected ITEM-2 668, in order to use the file or distribute the file to other network nodes.

According to a further preferred embodiment of the present invention, a network node purchases an IP protected item from a service node, a network control node or from a repository network node, on a pay-per-view basis. In this case, the network node pays the service node for a one-time use of the IP protected item.

The network node sends a pay-per-view request to a service node, to a network control node or to a repository network node. The respective node provides for verification of the user sensitive information, performance of a financial transaction, encryption of the requested IP protected item and uploading of the encrypted IP protected item to the network node, as described herein above. It is noted that the network node can not store the downloaded encrypted IP protected item in a non-volatile storage medium. The network node decrypts the encrypted downloaded IP protected item according to the user sensitive information thereof and uses the IP protected item, immediately. Thus, the network node can use the IP protected item for only one time.

Following is a description of a scenario in which a network node sends an upload request to a repository network node, to upload an infringing item. Network node 670 sends an upload request to repository network node 654 to upload modified ITEM-2 666 to network node 670. If repository network node 654 is not occupied when receiving the upload request from network node 670, then repository network node 654 uploads modified ITEM-2 666 to network node 670. If repository network node 654 is occupied when receiving the upload request from network node 670, then repository network node 654 sends the upload request to network control node 652. Network control node 652 identifies a repository network node, which is not occupied, such as repository network node 656. Repository network node 656, then uploads modified ITEM-2 666 to network node 670.

The supplementary material in modified ITEM-2 666 which network node 670 downloads from repository network node 656, is similar to the supplementary material as described herein above (i.e., the supplementary material is a notice, a purchase offer, or includes at least one link to at least one network site, wherein the network site includes a purchase offer or a membership offer). Network node 670 can purchase and download IP protected ITEM-2 668 (i.e., a usable copy of modified ITEM-2 666), from repository network node 656, by accepting the purchase offer and performing a transaction, as described herein above. Alternatively, network node 670 connects to the network site via the link, which is included in the supplementary material. Network node 670 accepts either the purchase offer or the membership offer. Alternatively, network node 670 denies either the purchase offer or the membership offer.

According to another aspect of the present invention, network control node 652 controls the operation of repository network nodes 654 and 656, through a control layer, logically located above or within the communication protocols used to establish the network. Network control node 652 communicates with repository network nodes 654 and 656 in this control layer, according to a control application which runs in network control node 652 and repository network nodes 654 and 656. The control application controls the operation of each of repository network nodes 654 and 656 and enables the following operations in computer system 650.

When network control node 652 uploads an item, such as modified ITEM-2 666, from storage unit 662 to repository network node 654, the control application enables repository network node 654, to upload the downloaded item to other repository network nodes coupled to network 674, such as repository network node 656. The control application of repository network node 656, in turn directs repository network node 656 to upload the downloaded item to other repository network nodes coupled to network 674. In this manner, an item is uploaded from storage unit 662 of network control node 652 to a plurality of repository network nodes coupled to network 674, by employing only the connection between network control node 652 and only one repository network node. Thus, computer system 650, conserves valuable system resources, such as bandwidth, central processing unit (CPU) time, and the like.

The control application enables repository network node 654 to download an update of the control application, from network control node 652. The control application enables repository network node 654 to download an update of the item characteristics list of the shared-items directory, from network control node 652. Each of the item characteristics in the list, includes at least one pointer to those repository network nodes, which include one or more of these items, at any given time. These items are either IP protected items or modified copies of IP protected items.

The control application enables repository network node 654 to download an update of the shared-items directory from network control node 652. Thus, repository network node 654 receives an updated content of each of the modified items and the IP protected items and the characteristics thereof.

The control application enables repository network node 654 to download one or more screen savers with changing content, from network control node 652. The changing content can be advertisements, IP protected items and the like, provided and updated by network control node 652 from time to time.

The control application enables repository network node 654 to send information to network control node 652, respective of the total time which repository network node 654 was coupled to network 674, during a given time period. The control application enables repository network node 654 to send information to network control node 652, respective of one or more download requests which repository network node 654 receives from network node 670, during a given time period, the uploaded volume, and the like.

The control application enables repository network node 654 to send information to network control node 652, respective of the items, or modified copies of items, which repository network node 654 has uploaded to network node 670, in a given time period. The control application enables repository network node 654 to send information to network control node 652, respective of the total CPU time which repository network node 654 has consumed, in a given time period. The control application can also modify the shared-items directory, within repository network node 654.

The control application enables repository network node 654 to send information to network control node 652 in the form of activity reports, from time to time, respective of the overall download and upload operation thereof, in many aspects such as the following:

The number of times which one or more network connections were disconnected, in a given time period (e.g., these network connections are established between repository network node 654 and network node 670, or network node 672).

The bandwidth in one or more connections between repository network node 654 and downloading network nodes, in a given time period.

The network protocol addresses of one or more network nodes, which had sent requests to repository network node 654, in a given time period.

The most popular IP items that were either requested or downloaded.

According to activity reports which network control node 652 receives from each of the repository network nodes, network control node 652 monitors the operational level of each of the repository network nodes, and rates the activity thereof, in a given time period. For example, network control node 652 refers to the activity reports of each of repository network nodes 654 and 656, and determines that repository network node 654 has uploaded modified ITEM-2 666 twenty times between Mar., 10, 2001 and Mar., 17, 2001. Network control node 652 further determines that repository network node 656 has uploaded modified ITEM-2 666 thirty times within the same period. Thus, network control node 652 determines that repository network node 656 has been more active than repository network node 654 during this period, and rewards repository network node 656, accordingly. Alternatively, network control node 652 determines that the load on repository network node 656 is greater than that of repository network node 654, and thus network control node 652 increases the load on repository network node 654.

Repository network node 654, periodically changes an attribute thereof, such as network interface card (NIC) identification, logical user name, the network service provider, network protocol address, and the like. Repository network node 654 needs to log-off and log-on to network 674, while changing the attribute thereof. The control application initiates a log-off and a log-on script in repository network node 654, in the process of changing the attribute of repository network node 654.

When network server 658 receives a network notification command, such as a ping command, and the like, from repository network node 654, network server 658 records the network protocol address and the port number of repository network node 654, in the logged-on list. Repository network node 654, sends a network notification command to network server 658, at predetermined time intervals. Thus, repository network node 654 increases the probability that the network protocol address and the port number of repository network node 654, is listed in the logged-on list, at any given time. Hence, the probability that network node 670 downloads the queried item (i.e., a modified copy of the queried item), from repository network node 654, is greater. The control application enables repository network node 654 to send a network notification command to network server 658, automatically, at predetermined time intervals.

If the resources of repository network node 654, such as bandwidth, memory, processing time, and the like, are restricted, then repository network node 654 degenerates the routing capacity thereof. For example, repository network node 654 ceases to send network notification commands (i.e., sending ping commands), respond to network notification commands (i.e., sending pong commands), respond to or forward queries, and the like.

The control application enables network control node 652, to control the uploading process of an item (i.e., an IP protected item or a modified copy of the IP protected item), from repository network node 654 to network node 670, when repository network node 654 starts to upload the item to network node 670. When repository network node 654 ceases to upload the item to network node 670 during this uploading process, network control node 652 directs repository network node 656 to upload the remaining portion of the item to network node 670. Alternatively, when repository network node 654 ceases to upload the item to network node 670 during this uploading process, network control node 652 uploads the remaining portion of the item, from storage unit 662 to network node 670.

According to a further preferred embodiment, network control node 652 signs modified ITEM-1 664₁, modified ITEM-2 666, modified ITEM-N 664_{N} and IP protected ITEM-2 668 with a digital signature, before uploading these items to repository network nodes, such as repository network node 654. This digital signature can be used for identifying items, retrieved from network nodes throughout the network. Thus, network control node 652 can identify the modified items which network control node 652 had previously uploaded to network 674, in network node 670 and in network node 672.

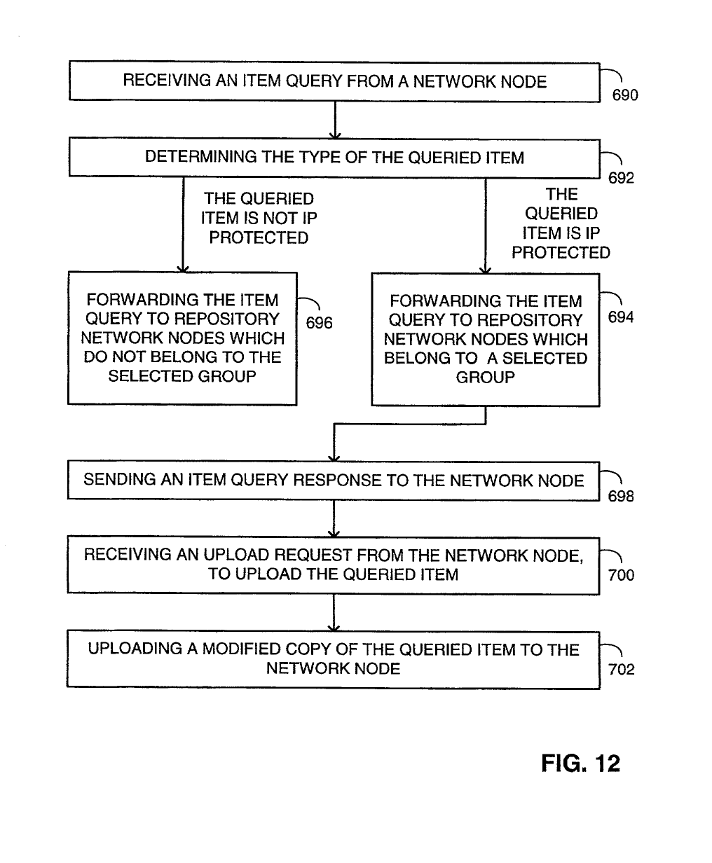

Reference is now made to FIG. 12, which is a schematic illustration of a method for uploading a queried item to a network node, operative in accordance with a further preferred embodiment of the present invention. In step 690, an item query is received from a network node. With reference to FIG. 11, repository network node 654 receives an item query from network node 670, wherein network node 670 queries an item in repository network node 654.

In step 692, the type of the queried item is determined. With reference to FIG. 11, repository network node 654 determines the type of the queried item, by comparing the characteristics of the queried item, with the entries in the item characteristics list of the shared-items directory. If the characteristics of the queried item match an entry in the item characteristics list, then repository network node 654 determines that the queried item is an IP protected item, such as ITEM-2. If the characteristics of the queried item do not match any entry in the item characteristics list, then repository network node 654 determines that the queried item is not an IP protected item.

When the queried item is IP protected, repository network node 654 forwards the item query to repository network nodes which belong to a selected group of repository network nodes, such as repository network node 656 (step 694). Repository network node 656, in turn forwards the item query to other repository network nodes (not shown in FIG. 11), which belong to the selected group. The latter repository network nodes, forward the item query further on to other repository network nodes in the selected group, and so on.

When the queried item is not IP protected, repository network node 654 forwards the item query to repository network nodes which do not belong to the selected group of repository network nodes, such as network node 672 (step 696). Network node 672 sends an item query response (not shown) to network node 670, notifying network node 670 that the queried item (which is not IP protected), resides in network node 672. Network node 670 sends an upload request (not shown) to network node 672, to upload the queried item (which is not IP protected), to network node 670. If network node 672 accepts the upload request, then network node 672 uploads the queried item to network node 670 (not shown).

In step 698, an item query response is sent to the network node. With reference to FIG. 11, repository network node 654 sends an item query response to network node 670, notifying network node 670, that the queried item (i.e., ITEM-2, which is IP protected), resides in repository network node 654.

In step 700, an upload request is received from the network node, to upload the queried item. With reference to FIG. 11, repository network node 654 receives an upload request from network node 670, to upload the queried item (i.e., ITEM-2), to network node 670. Repository network node 654, then uploads a modified copy of ITEM-2 (i.e., modified ITEM-2 666), to network node 670 (step 702).

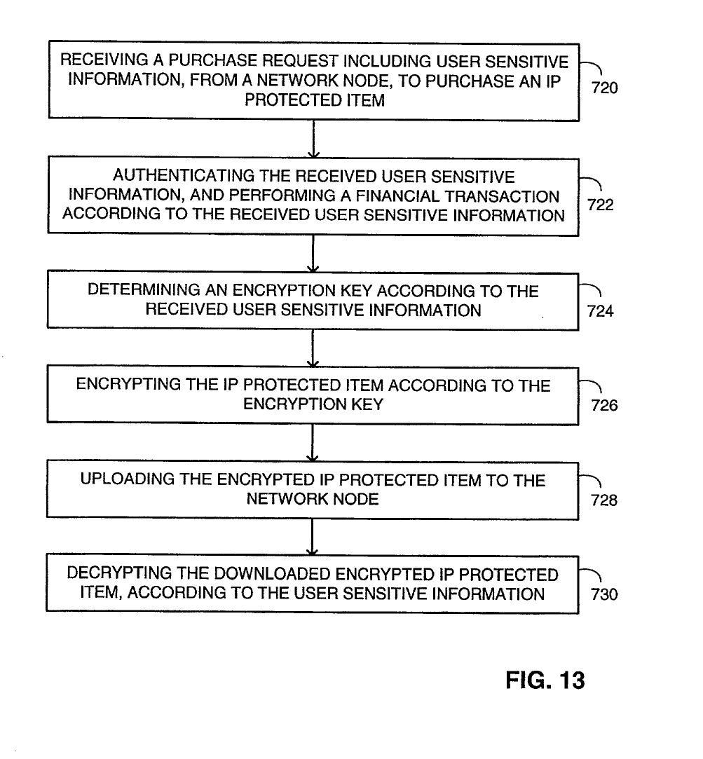

Reference is now made to FIG. 13, which is a schematic illustration of a method for purchasing an IP protected item, operative in accordance with another preferred embodiment of the present invention. In step 720, a purchase request, including user sensitive information, is received from a network node, to purchase an IP protected item. With reference to FIG. 11, repository network node 656 receives a purchase request from network node 670, to purchase IP protected ITEM-2. Repository network node 656 receives also user sensitive information respective of network node 670, such as credit card number, bank account number, and the like of the user of network node 670.

In step 722, the received user sensitive information is authenticated and a financial transaction is performed, according to the received user sensitive information. With reference to FIG. 11, repository network node 656 sends the user sensitive information to network control node 652. Network control node 652 authenticates the received user sensitive information (i.e., the credit card number or the band account number), for example, by establishing connection with the credit card service provider of the user of network node 670. Simultaneously, network control node 652 performs a financial transaction for the purchase of IP protected ITEM-2 666, through the credit card service provider, according to the received credit card number.

In step 724, an encryption key is determined according to the received user sensitive information. With reference to FIG. 11, network control node 652 determines an encryption key for encrypting IP protected ITEM-2 666, according to the received credit card number, by employing an encryption algorithm. For example, network control node 652 determines the encryption key, by applying a one-way function to all digits of the received credit card number. Network control node 652 sends the encryption key to repository network node 656.

In step 726, the IP protected item is encrypted according to the encryption key. With reference to FIG. 11, repository network node 656 encrypts IP protected ITEM-2 666 according to the received encryption key. Alternatively, network control node 652 encrypts IP protected ITEM-2 666 according to the determined encryption key and sends the encrypted version of IP protected ITEM-2 666 to repository network node 656.

In step 728, the encrypted IP protected item is uploaded to the network node. With reference to FIG. 11, repository network node 656 uploads the encrypted version of IP protected ITEM-2 666, to network node 670.

In step 730, the downloaded encrypted IP protected item is decrypted, according to the user sensitive information. With reference to FIG. 11, network node 670 decrypts the encrypted version of IP protected ITEM-2 666, which repository network node 656 uploads to network node 670, according to the credit card number of the user of network node 670.

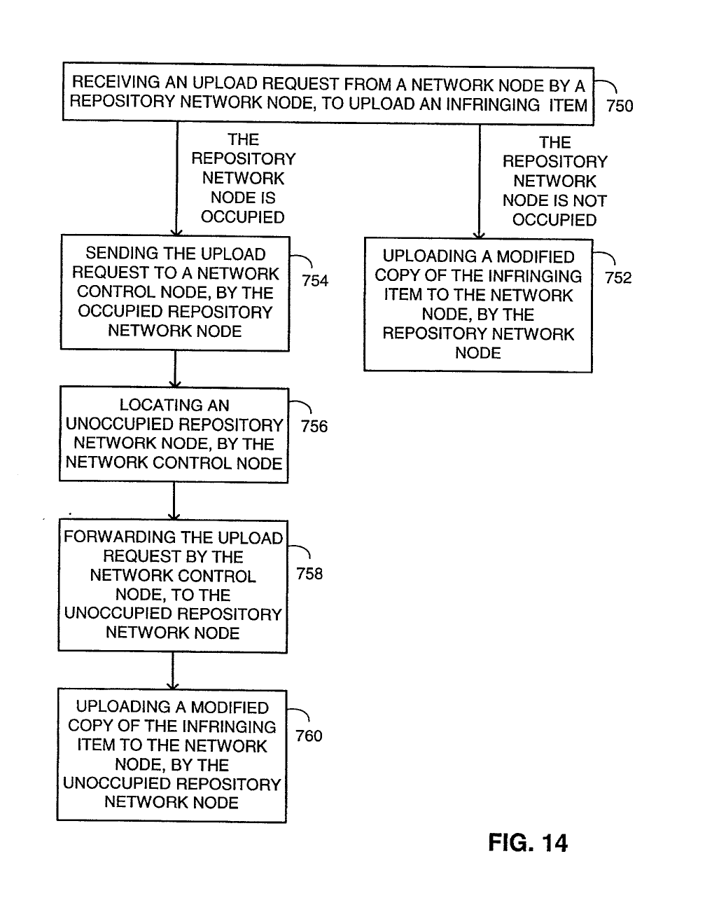

Reference is now made to FIG. 14, which is a schematic illustration of a method for uploading an infringing item to a network node, operative in accordance with a further preferred embodiment of the present invention. In step 750, a repository network node receives an upload request from a network node to upload an infringing item. With reference to FIG. 11, repository network node 656 receives an upload request from network node 670, to upload an infringing item, such as ITEM-2 to network node 670. When repository network node 656 is not occupied, repository network node 656 uploads modified ITEM-2 666 to network node 670 (step 752).

In step 754, the upload request is sent to a network control node by the repository network node, when the repository network node is occupied. With reference to FIG. 11, repository network node 656 which receives the upload request, is occupied and hence, repository network node 656 sends the upload request to network control node 652. Network control node 652, then locates a repository network node which is not occupied, such as repository network node 654 (step 756) and network control node 652 forwards the upload request to repository network node 654 (step 758). Repository network node 654, then uploads modified ITEM-2 666 to network node 670 (step 760).

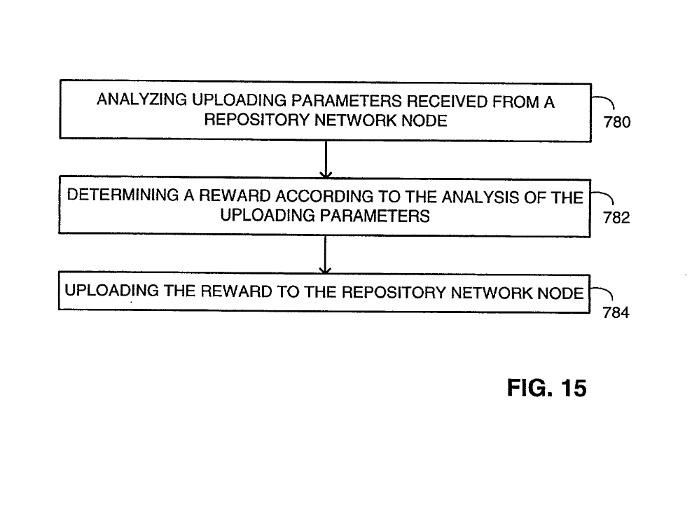

Reference is now made to FIG. 15, which is a schematic illustration of a method for rewarding a repository network node, operative in accordance with another preferred embodiment of the present invention. In step 780, the uploading parameters which are received from a repository network node, are analyzed. With reference to FIG. 11, network control node 652 analyzes the activity report (as described herein above), received from repository network node 656.

The activity report includes information respective of the items which repository network node uploads to network node 670, in a given period of time. Such information includes for example, the total volume of the uploaded modified items, the total volume of the uploaded (i.e., sold) IP protected items, the total CPU time consumed, and the like. Network control node 652 analyzes the received activity report, by comparing the activity report of repository network node 656, with activity reports of other repository network nodes, such as repository network node 654 and determines to offer a reward to repository network node 656.

In step 782, a reward is determined according to the analysis of the uploading parameters. With reference to FIG. 11, network control node 652 determines to upload a screensaver to repository network node 656, as a reward for the operation of repository network node 656, in a given period of time. Network control node 652, then uploads the screensaver to repository network node 656 (step 784).

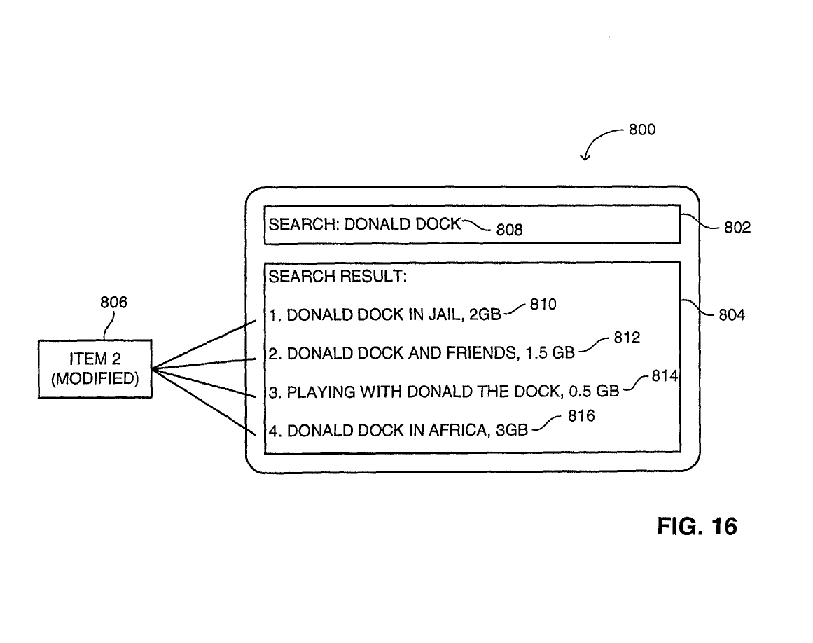

Reference is now made to FIG. 16, which is a schematic illustration of a network node display, generally referenced 800, constructed and operative in accordance with a further preferred embodiment of the present invention. Display 800 includes a search request section 802 and a search result section 804.

A repository network node (not shown) generates a modified item property list for each of the modified items, such as modified ITEM-2 806, which resides in the repository network node. The modified item property list includes a list of strings for the modified ITEM-2 806 and a fictitious file size for each string.

For example, if modified ITEM-2 806 is a video whose subject is “Donald Dock”, the modified item property list for modified ITEM-2 806 includes a plurality of popular titles which correspond with “Donald Dock” (item 808), such as “Donald Dock in Jail” (item 810), “Donald Dock and Friends” (item 812), “Playing with Donald the Dock” (item 814), “Donald Dock in Africa” (item 816), and the like. Items 810, 812, 814 and 816 in the modified item property list, include file size entries of 2 GB, 1.5 GB, 0.5 GB and 3 GB, respectively.

A network node (not shown) searches the repository network node for “Donald Dock” titles, by keying in the phrase “Donald Dock” in search request section 802. The repository network node responds to the search request, by sending the network node the modified item property list which corresponds with “Donald Dock”. Items 810, 812, 814 and 816 and the respective file sizes are displayed in search result section 804. The person operating the network node, selects an item from the search result, such as item 812, and the network node sends the repository network node an upload request, to upload item 812 (i.e., “Donald Dock and Friends”) to the network node. The repository network node uploads modified ITEM-2 806 which corresponds with item 812, to the network node.

Since a different file size is indicated for each of the items 810, 812, 814 and 816 in the search result, the person operating the network node believes that the search result is genuine and hence sends an upload request to the repository network node. Thus, by sending the network node the modified item property list, the probability that the network node downloads a modified copy of an IP protected item is increased.

It will be appreciated by persons skilled in the art that the present invention is not limited to what has been particularly shown and described herein above. Rather the scope of the present invention is defined only by the claims, which follow.

1. Repository network node, for communicating with a plurality of network nodes, over a network, wherein selected ones of the network nodes are repository network nodes, the repository network node comprising:
a network interface coupled to said network; and
a processor coupled to said network interface,
wherein said network interface receives an item query from another network node, via said network,
wherein said processor forwards said item query to selected ones of said repository network nodes, when said item query is directed at intellectual property protected items, and
wherein said processor forwards said item query to selected non repository network nodes of said network nodes, when said item query is not directed at intellectual property protected items.

2. The repository network node according to claim 1, wherein the type of content of said intellectual property protected items is selected from the list consisting of:
audio;
video;
software;
computer game;
data; and
e-book.

3. The repository network node according to claim 1, wherein the type of the coupling between said network interface and said network is selected from the list consisting of:
wireless link; and
wired.

4. The repository network node according to claim 1, wherein the type of said network is selected from the list consisting of:
publicly accessed network; and
network application.

5. The repository network node according to claim 1, wherein said repository network node is a device selected from the list consisting of:
desktop;
laptop;
workstation;
mobile unit; and
network user application.

6. The repository network node according to claim 1, wherein said repository network node periodically changes at least one attribute respective thereof.

7. The repository network node according to claim 6, wherein said at least one attribute is selected from the list consisting of:
network interface card identification;
logical user name;
network service provider; and
network protocol address.

8. The repository network node according to claim 1, wherein said repository network node has at least one identity.

9. The repository network node according to claim 8, wherein said at least one identity is selected from the list consisting of:
media access control address;
network protocol address;
user name; and
uniform resource locator.

10. The repository network node according to claim 1, wherein at least one network server is coupled to said network, said at least one network server includes a logged-on list,
wherein said logged-on list includes the network protocol addresses of said selected repository network nodes.

11. The repository network node according to claim 10, wherein the type of said at least one network server is selected from the list consisting of:
centralized;
distributed; and
search engine.

12. The repository network node according to claim 1, wherein each of said selected repository network nodes forwards said item query to other ones of said selected repository network nodes, and
wherein each of said selected non repository network nodes forwards said item query to other ones of said selected non repository network nodes.

13. The repository network node according to claim 1, wherein each of said selected repository network nodes sends an item query response to said another network node, when said item query is directed at said intellectual property protected items, and
wherein each of said selected non repository network nodes sends said item query response to said another network node, when said item query is not directed at said intellectual property protected items.

14. Repository network node, selected from a plurality of repository network nodes, the repository network nodes communicating with a plurality of network nodes, over a network, the repository network node comprising:
a network interface coupled to said network; and
a processor coupled to said network interface,
wherein said processor receives item queries from said network nodes via said network interface, said item queries being respective of intellectual property protected items,
wherein said processor sends information respective of said item queries to a network control node, for use by said network control node for the operation of said selected repository network nodes, according to said information.

15. The repository network node according to claim 14, wherein said network control node controls the operation of said repository network nodes, by running a control application in each of said repository network nodes.

16. The repository network node according to claim 15, wherein said control application enables each of said selected repository network nodes to send a network notification command to at least one network server, automatically, at predetermined time intervals.

17. The repository network node according to claim 15, wherein said control application enables each of said selected repository network nodes, to send a modified copy of a selected one of said intellectual property protected items, to other ones of said selected repository network nodes, when said network control node sends said modified copy to said selected repository network node.

18. The repository network node according to claim 15, wherein said control application enables each of said selected repository network nodes to download an update of said control application from said network control node.

19. The repository network node according to claim 15, wherein said control application enables each of said selected repository network nodes, to download an update of an item characteristics list of said intellectual property protected items, and modified copies of said intellectual property protected items from said network control node,
wherein each of said item characteristics includes at least one pointer to at least one of said selected repository network nodes, and
wherein said at least one selected repository network node includes at least one of said intellectual property protected items, and at least one of said modified copies, at any given time.

20. The repository network node according to claim 15, wherein said control application enables each of said selected repository network nodes, to download an update of a shared-items directory, from said network control node,
wherein said shared-items directory includes said intellectual property protected items and modified copies of said intellectual property protected items, and
wherein said shared-items directory further includes an item characteristics list of said intellectual property protected items and of said modified copies.

21. The repository network node according to claim 15, wherein said control application enables each of said selected repository network nodes, to download at least one screen saver with changing content, from said network control node.

22. The repository network node according to claim 21, wherein said changing content is selected from the list consisting of:
advertisement; and
said IP protected item.

23. The repository network node according to claim 15, wherein said control application initiates a log-on and a log-off script in each of said selected repository network nodes, when said selected repository network node determines to change at least one attribute thereof.

24. The repository network node according to claim 23, wherein said at least one attribute is selected from the list consisting of:
network interface card identification;
logical user name;
network service provider; and
network protocol address.

25. The repository network node according to claim 15, wherein said control application running in said network control node, enables said network control node to direct a selected one of said repository network nodes to upload the remaining portion of a selected one of said intellectual property protected items, to a selected one of said network nodes, when another one of said selected repository network nodes, ceases to upload said remaining portion to said selected network node.

26. The repository network node according to claim 15, wherein said control application running in said network control node, enables said network control node to direct a selected one of said repository network nodes to upload the remaining portion of a modified copy of a selected one of said intellectual property protected items, to a selected one of said network nodes, when another one of said selected repository network nodes, ceases to upload said remaining portion to said selected network node.

27. The repository network node according to claim 15, wherein said control application running in said network control node, enables said network control node to upload the remaining portion of a selected one of said intellectual property protected items, to a selected one of said network nodes, when a selected one of said repository network nodes, ceases to upload said remaining portion to said selected network node.

28. The repository network node according to claim 15, wherein said control application running in said network control node, enables said network control node to upload the remaining portion of a modified copy of a selected one of said intellectual property protected items, to a selected one of said network nodes, when a selected one of said repository network nodes, ceases to upload said remaining portion to said selected network node.

29. The repository network node according to claim 14, wherein each of said selected repository network nodes degenerates the routing capacity thereof, when the resources thereof are restricted.

30. The repository network node according to claim 29, wherein the type of said resources is selected from the list consisting of:
bandwidth;
memory; and
processing time.

31. Network control node, for controlling the operation of a plurality of repository network nodes, the repository network nodes communicating with a plurality of network nodes, over a network, the network control node comprising:
a network interface coupled to said network; and
a processor coupled to said network interface,
wherein said network control node receives information from said repository network nodes, respective of item queries which said repository network nodes receive from said network nodes, said item queries being respective of intellectual property protected items, and
wherein said network control node controls the operation of said repository network nodes according to said information.

32. The network control node according to claim 31, wherein said network control node controls the operation of said repository network nodes, by running_a control application in each of said repository network nodes.

33. The network control node according to claim 32, wherein said control application enables each of said repository network nodes to send a network notification command to at least one network server, automatically, at predetermined time intervals.

34. The network control node according to claim 32, wherein said control application enables each of said repository network nodes, to send a modified copy of a selected one of said intellectual property protected items, to other ones of said repository network nodes, when said network control node sends said modified copy to said repository network node.

35. The network control node according to claim 32, wherein said control application enables each of said repository network nodes to download an update of said control application from said network control node.

36. The network control node according to claim 32, wherein said control application enables each of said repository network nodes, to download an update of an item characteristics list of said intellectual property protected items, and modified copies of said intellectual property protected items from said network control node,
wherein each of said item characteristics includes at least one pointer to at least one of said repository network nodes, and
wherein each of said at least one repository network node includes at least one of said intellectual property protected items, and at least one of said modified copies, at any given time.

37. The network control node according to claim 32, wherein said control application enables each of said repository network nodes, to download an update of a shared-items directory, from said network control node,
wherein said shared-items directory includes said intellectual property protected items and modified copies of said intellectual property protected items, and
wherein said shared-items directory further includes an item characteristics list of said intellectual property protected items and of said modified copies.

38. The network control node according to claim 32, wherein said control application enables each of said repository network nodes, to download at least one screen saver with changing content, from said network control node.

39. The network control node according to claim 38, wherein said changing content is selected from the list consisting of:
advertisement; and
said IP protected item.

40. The network control node according to claim 32, wherein said control application modifies a shared-items directory included in each of said repository network nodes.

41. The network control node according to claim 32, wherein said control application initiates a log-on and a log-off script in each of said repository network nodes, when said repository network node determines to change an attribute thereof.

42. The network control node according to claim 32, wherein said control application running in said network control node, enables said network control node to direct a selected one of said repository network nodes to upload the remaining portion of a selected one of said intellectual property protected items, to a selected one of said network nodes, when another one of said selected repository network nodes, ceases to upload said remaining portion to said selected network node.

43. The network control node according to claim 32, wherein said control application running in said network control node, enables said network control node to direct a selected one of said repository network nodes to upload the remaining portion of a modified copy of a selected one of said intellectual property protected items, to a selected one of said network nodes, when another one of said selected repository network nodes, ceases to upload said remaining portion to said selected network node.

44. The network control node according to claim 32, wherein said control application running in said network control node, enables said network control node to upload the remaining portion of a selected one of said intellectual property protected items, to a selected one of said network nodes, when a selected one of said repository network nodes, ceases to upload said remaining portion to said selected network node.

45. The network control node according to claim 32, wherein said control application running in said network control node, enables said network control node to upload the remaining portion of a modified copy of a selected one of said intellectual property protected items, to a selected one of said network nodes, when a selected one of said repository network nodes, ceases to upload said remaining portion to said selected network node.

46. The network control node according to claim 31, wherein said information is respective of the total time which each of said repository network nodes was connected to said network, during a given time period.

47. The network control node according to claim 31, wherein said information is respective of at least one upload request which each of said repository network nodes receives from at least one of said network nodes, and respective of the total volume of said intellectual property protected items and modified copies of said intellectual property protected items, which each of said repository network nodes uploads to said at least one network node, during a given time period.

48. The network control node according to claim 31, wherein said information is respective of at least one of said intellectual property protected items and at least one modified copy of said at least one of intellectual property protected item, which each of said repository network nodes uploads to at least one of said network nodes, during a given time period.

49. The network control node according to claim 31, wherein said information is respective of the total central processing unit time, which each of said repository network nodes consumes, during a given time period.

50. The network control node according to claim 31, wherein said information includes an activity report respective of said item queries.

51. The network control node according to claim 45, wherein said activity report includes a plurality of entries selected from the list consisting of:
number of times which at least one network connection between each of said repository network nodes and at least one of said network nodes, is disconnected in a given time period;
bandwidth of at least one other network connection between each of said repository network nodes and said network control node;
network protocol address of each said network nodes, which sends an item request to each of said repository network nodes, in a given time period;
most popular ones of said intellectual property protected items which each of said at least one network node requests from each of said repository network nodes, in a given time period; and
most popular ones of at least one modified copy of at least one of said intellectual property protected items, which each of said repository network nodes uploads to each of said at least one network node, in a given time period.

52. The network control node according to claim 31, wherein said network control node signs each of said intellectual property protected items with a digital signature, before uploading said intellectual property protected item to each of said repository network nodes, whereby said network control node identifies a selected one of said intellectual property protected items, which resides in a selected one of said network nodes.

53. The network control node according to claim 31, wherein said network control node signs modified copies of each of said intellectual property protected items with a digital signature, before uploading said intellectual property protected item to each of said repository network nodes, whereby said network control node identifies a selected one of said modified copies, which resides in a selected one of said network nodes.

54. Network control node, for balancing the load among a plurality of repository network nodes, the repository network nodes communicating with a plurality of network nodes, over a network, the network control node comprising:
a network interface coupled to said network; and
a processor coupled to said network interface,
wherein said network control node receives an activity report from each of said repository network nodes, said activity report being respective of item queries which said repository network nodes receive from each of said network nodes, said item queries being respective of intellectual property protected items, and
wherein said network control node balances the load among said repository network nodes, by comparing said activity report with other activity reports received from other ones of said repository network nodes.

55. The network control node according to claim 54, wherein said activity report includes a plurality of entries selected from the list consisting of:
number of times which at least one network connection between each of said repository network nodes and at least one of said network nodes, is disconnected in a given time period;
bandwidth of at least one other network connection between each of said repository network nodes and said network control node;
network protocol address of each said network nodes, which sends an item request to each of said repository network nodes, in a given time period;
most popular ones of said intellectual property protected items which each of said at least one network node requests from each of said repository network nodes, in a given time period; and
most popular ones of at least one modified copy of at least one of said intellectual property protected items, which each of said repository network nodes uploads to each of said at least one network node, in a given time period.

56. The network control node according to claim 54, wherein said network control node determines whether to offer a reward to a selected repository network node, according to the outcome of said comparison.

57. The network control node according to claim 54, wherein said reward is selected from the list consisting of:
IP protected item;
license to use said IP protected item;
screen saver including a changing content;
movie ticket; and
financial incentive.

58. The network control node according to claim 57, wherein said changing content is selected from the list consisting of:
advertisement; and
said IP protected item.

59. Modified item, comprising:
at least one modified item characteristic; and
modified item content,
wherein said modified item is produced according to at least one item characteristic of an item, item content of said item and at least one supplementary material.

60. The modified item according to claim 59, wherein said at least one supplementary material is a notice that said modified item is a modified copy of an intellectual property protected item.

61. The modified item according to claim 60, wherein said at least one supplementary material is in a form selected from the list consisting of:
text;
graphics;
animation; and
voice.

62. The modified item according to claim 60, wherein the beginning portion of said modified item before said at least one supplementary material is usable, whereby a network node continues to download said modified item, after examining said beginning portion.

63. The modified item according to claim 59, wherein said at least one supplementary material is a purchase offer for a network node which downloads said modified item, to purchase a usable copy of said modified item.

64. The modified item according to claim 59, wherein said at least one supplementary material includes at least one link to at least one network site, and
wherein said at least one network site includes a purchase offer for a network node which downloads said modified item, to purchase a usable copy of said modified item.

65. The modified item according to claim 59, wherein said at least one supplementary material includes at least one link to at least one network site, and
wherein said at least one network site includes a membership offer for a network node which downloads said modified item, to operate similar to a repository network node,
wherein said repository network node uploads a modified copy of an intellectual property protected item to another one of said network node, when said repository network node receives an upload request from said another network node, to upload said intellectual property protected item.

66. Method for uploading an item to a network node, over a network, the method comprising the steps of:
determining the type of said item; and
forwarding an item query to a plurality of selected repository network nodes which belong to a selected group of repository network nodes, when said item is intellectual property (IP) protected, and forwarding said item query to a plurality of other repository network nodes which do not belong to said selected group, when said item is not IP protected.

67. The method according to claim 66, further comprising a preliminary step of receiving said item query by each of said selected repository network nodes, from said network node.

68. The method according to claim 67, further comprising a preliminary step of receiving a logged-on list by said network node, from a network server, over said network.

69. The method according to claim 68, further comprising a preliminary step of sending a logged-on query by said network node, to said network server.

70. The method according to claim 66, further comprising a step of sending an item query response to said network node, by each of said selected repository network nodes, which belongs to said selected group.

71. The method according to claim 70, further comprising a step of receiving an upload request from said network node, by a selected repository network node which belongs to said selected group, to upload said item.

72. The method according to claim 71, further comprising a step of uploading a modified copy of said item to said network node, by said selected repository network node.

73. The method according to claim 66, further comprising a step of sending an item query response to said network node, by each of said other repository network nodes which does not belong to said selected group.

74. The method according to claim 73, further comprising a step of receiving an upload request from said network node, by a selected one of said other repository network nodes, to upload said item.

75. The method according to claim 74, further comprising a step of uploading said item to said network node, by said selected other repository network node.

76. The method according to claim 66, wherein said step of determining further comprises a procedure of comparing at least one characteristic of said item, with at least one entry in an item characteristics list,
wherein said item characteristics list is located in a shared-items directory, said shared-items directory further includes said item, said shared-items directory is located in each of said selected repository network nodes,
wherein said item is IP protected when said at least one characteristic matches said at least one entry, and
wherein said item is not IP protected when said at least one characteristic does not match said at least one entry.

77. The method according to claim 66, further comprising a step of controlling the operation of each of said selected repository network nodes, by a control application.

78. The method according to claim 77, further comprising a step of updating said shared-items directory, by said control application.

79. The method according to claim 77, further comprising a step of modifying said shared-items directory, by said control application.

80. The method according to claim 77, further comprising a step of downloading an update of said control application from a network control node.

81. The method according to claim 66, further comprising a step of producing at least one translated name for said item,
wherein said at least one translated name is produced by a translator coupled to said network, according to at least one item characteristic of said item, for identifying said at least one translated name by each of said selected repository network nodes associated with another translator similar to said translator.

82. The method according to claim 66, further comprising a step of periodically changing at least one attribute respective of each of said selected repository network nodes.

83. The system according to claim 82, wherein said at least one attribute is selected from the list consisting of:
network interface card identification;
logical user name;
network service provider; and
network protocol address.

84. The method according to claim 66, further comprising a step of initiating a log-off and a log-on script in each of said selected repository network nodes, by a control application.

85. The method according to claim 72, wherein said step of uploading is performed at a high quality of service, during the uploading of the beginning portion of a modified copy of said item, and at a low quality of service during the uploading of the remainder of said modified copy.

86. The method according to claim 72, wherein the quality of service is alternated between a high value and a low value, while performing said step of uploading.

87. The method according to claim 66, further comprising a step of automatically sending a network notification command to at least one network server, over said network, by each of said selected repository network nodes, at predetermined time intervals.

88. The method according to claim 67, further comprising a step of sending information to a network control node, respective of said step of receiving.

89. The method according to claim 72, further comprising a step of sending information to a network control node, respective of said step of uploading.

90. The method according to claim 72, further comprising a step of sending information to a network control node, respective of said modified copy.

91. The method according to claim 77, wherein said control application enables each of said selected repository network nodes, to send periodically an activity report to a network control node.

92. The method according to claim 91, wherein said activity report includes a plurality of entries selected from the list consisting of:
number of times which at least one network connection between each of said selected repository network nodes and said network node, is disconnected in a given time period;
bandwidth of at least one other network connection between each of said selected repository network nodes and said network control node;
network protocol address of said network node, which sends said item query to each of said selected repository network nodes, in a given time period;
most popular ones of a plurality of items which said network node queries from each of said selected repository network nodes, in a given time period; and
most popular ones of at least one modified copy of said items which each of said selected repository network nodes uploads to said network node, in a given time period.

93. The method according to claim 91, further comprising a step of monitoring the activity of a repository network node, by said network control node, by comparing said activity report of said repository network node, with said activity report of another repository network node,
wherein said repository network node and said another repository network node belong to said selected group.

94. The method according to claim 93, further comprising a step of adjusting the load on a selected repository network node, by said network control node, according to the outcome of said comparison step,
wherein said selected repository network node belongs to said selected group.

95. The method according to claim 91, further comprising a step of rating the activity of a selected repository network node, by said network control node, by comparing said activity report of said selected repository network node, with said activity report of another selected repository network node,
wherein said repository network node and said another repository network node belong to said selected group.

96. The method according to claim 95, further comprising a step of determining by said network control node, whether to offer a reward to said selected repository network node, according to the outcome of said comparison step.

97. The method according to claim 66, further comprising a step of degenerating the routing capacity by a selected repository network node, when the resources thereof are restricted.
wherein said selected repository network node belongs to said selected group.

98. The method according to claim 97, wherein the type of said resources is selected from the list consisting of:
bandwidth;
memory; and
processing time.

99. The method according to claim 66, further comprising a preliminary step of signing said item with a digital signature, by a network control node, whereby said network control node identifies a modified copy of said item,
wherein said modified copy resides in a selected one of said network nodes.

100. The method according to claim 72, wherein said step of uploading further comprises a procedure of directing a different one of said selected repository network nodes to upload the remaining portion of said modified copy to said network node, when said selected repository network node ceases to upload said modified copy to said network node, during said step of uploading,
wherein said step of directing is performed by a network control node.

101. The method according to claim 72, wherein said step of uploading further comprises a procedure of continuing the uploading of the remaining portion of said modified copy to said network node, by a network control node, when said selected repository network node ceases to upload said modified copy to said network node, during said step of uploading.

102. Method for purchasing an Intellectual Property (IP) protected item over a network, the method comprising the step of:
encrypting said IP protected item according to an encryption key, said encryption key determined according to user sensitive information.

103. The method according to claim 102, further comprising a preliminary step of determining said encryption key according to said user sensitive information.

104. The method according to claim 103, further comprising a preliminary step of authenticating said user sensitive information, and performing a financial transaction according to said user sensitive information.

105. The method according to claim 102, further comprising a step of decrypting a downloaded encrypted IP protected item, according to said user sensitive information.

106. The method according to claim 102, further comprising a preliminary step of receiving a purchase request and said user sensitive information from a network node.

107. The method according to claim 102, further comprising a step of uploading said encrypted IP protected item to a network node, after said step of encrypting.

108. The method according to claim 102, further comprising a step of using said encrypted IP protected item by a network node,
wherein said network node runs a playback application by providing said user sensitive information to a decryption algorithm.

109. The method according to claim 102, wherein the type of said user sensitive information is selected from the list consisting of:
credit card number;
social security number;
word;
number;
combination of letters and digits.

110. The method according to claim 106, further comprising a step of sending information to a network control node, respective of said step of receiving.

111. The method according to claim 107, further comprising a step of sending information to a network control node, respective of said step of uploading.

112. The method according to claim 102, further comprising a step of sending an activity report by a repository network node, to a network control node.

113. The method according to claim 112, wherein said activity report includes a plurality of entries selected from the list consisting of:
number of times which at least one network connection between said repository network node and a network node, is disconnected in a given time period;
bandwidth of at least one other network connection between said repository network node and said network control node;
network protocol address of said network node, which sends a purchase request to said repository network node, in a given time period, to purchase said IP protected item;
most popular IP protected items which said network node requests from said repository network node, in a given time period; and
most popular ones of said IP protected items which said repository network node uploads to said network node, in a given time period.

114. The method according to claim 112, further comprising a step of monitoring the activity of a selected one of a plurality of repository network nodes, by said network control node, by comparing said activity report of said selected repository network node, with said activity report of another selected one of said repository network nodes.

115. The method according to claim 114, further comprising a step of adjusting the load on said selected repository network node, by said network control node, according to the outcome of said comparison step.

116. The method according to claim 112, further comprising a step of rating the activity of a selected one of a plurality of repository network nodes, by said network control node, by comparing said activity report of said selected repository network node, with said activity report of another selected one of said repository network nodes.

117. The method according to claim 116, further comprising a step of determining by said network control node, whether to offer a reward to said selected repository network node, according to the outcome of said comparison step.

118. The method according to claim 102, further comprising a step of degenerating the routing capacity by a repository network node, when the resources thereof are restricted.

119. The method according to claim 118, wherein the type of said resources is selected from the list consisting of:
bandwidth;
memory; and
processing time.

120. The method according to claim 102, further comprising a preliminary step of signing said item with a digital signature, by a network control node, whereby said network control node identifies said IP protected item,
wherein said IP protected item resides in a selected network node.

121. The method according to claim 107, wherein said step of uploading further comprises a procedure of directing a repository network node to upload the remaining portion of said IP protected item to said network node, when a different repository network node ceases to upload said IP protected item to said network node, during said step of uploading,
wherein said step of directing is performed by a network control node.

122. The method according to claim 107, wherein said step of uploading further comprises a procedure of continuing the uploading of the remaining portion of said IP protected item to said network node, by a network control node, when said a repository network node ceases to upload said IP protected item to said network node, during said step of uploading.

123. The method according to claim 102, wherein said step of purchasing is performed on a pay-per-view basis.

124. Method for uploading a modified copy of an infringing item, to a network node, over a network, the method comprising the step of:
uploading said modified copy from a repository network node, when said repository network node is not occupied, and sending an upload request by said repository network node to a network control node, when said repository network node is occupied.

125. The method according to claim 124, further comprising a preliminary step of receiving said upload request by said repository network node, from said network node, to upload said infringing item.

126. The method according to claim 124, further comprising a step of locating an unoccupied repository network node, after said step of sending, wherein said network control node performs said step of locating.

127. The method according to claim 126, further comprising a step of forwarding said upload request to said unoccupied repository network node.

128. The method according to claim 127, further comprising a step of uploading said modified copy to said network node, by said unoccupied repository network node.

129. The method according to claim 128, wherein said network node proliferates said modified copy in said network, when said network node is not attended by the person who operates said network node.

130. The method according to claim 124, further comprising a preliminary step of retrieving said modified copy from a shared-items directory located in said repository network node.

131. The method according to claim 130, further comprising a step of updating said shared-items directory, by a control application.

132. The method according to claim 128, further comprising a preliminary step of retrieving said modified copy from a shared-items directory located in said unoccupied repository network node.

133. The method according to claim 132, further comprising a step of updating said shared-items directory, by a control application.

134. The method according to claim 126, further comprising a step of controlling the operation of said repository network node, and said unoccupied repository network node, by a control application.

135. The method according to claim 134, further comprising a step of downloading an update of said control application from a network control node.

136. The method according to claim 126, further comprising a step of producing at least one translated name for said modified copy,
wherein a translator coupled to said network produces said at least one translated name for said modified copy, according to at least one item characteristic of said modified copy, for identifying said at least one translated name by said repository network node and by said unoccupied repository network node, and
wherein each of said repository network node and said unoccupied repository network node is associated with another translator similar to said translator.

137. The method according to claim 126, further comprising a step of periodically changing at least one attribute respective of said repository network node and said unoccupied repository network node.

138. The system according to claim 137, wherein said at least one attribute is selected from the list consisting of:
network interface card identification;
logical user name;
network service provider; and
network protocol address.

139. The method according to claim 126, further comprising a step of initiating a log-off and a log-on script in said repository network node and in said unoccupied repository network node, by a control application.

140. The method according to claim 124, wherein said step of uploading is performed at a high quality of service, during the uploading of the beginning portion of said modified copy, and at a low quality of service during the uploading of the remainder of said modified copy.

141. The method according to claim 128, wherein said step of uploading by said unoccupied repository network node, is performed at a high quality of service, during the uploading of the beginning portion of said modified copy, and at a low quality of service during the uploading of the remainder of said modified copy.

142. The method according to claim 124, wherein the quality of service is alternated between a high value and a low value, while performing said step of uploading.

143. The method according to claim 128, wherein the quality of service is alternated between a high value and a low value, while performing said step of uploading by said unoccupied repository network node.

144. The method according to claim 124, further comprising a step of automatically sending a network notification command to a network control node over said network, by said repository network node, at predetermined time intervals.

145. The method according to claim 125, further comprising a step of sending information to said network control node, respective of said step of receiving.

146. The method according to claim 124, further comprising a step of sending information to said network control node, respective of said step of uploading.

147. The method according to claim 128, further comprising a step of sending information to said network control node, respective of said step of uploading by said unoccupied repository network node.

148. The method according to claim 124, further comprising a step of sending information to said network control node, respective of said modified copy.

149. The method according to claim 124, further comprising a step of sending an activity report by said repository network node, to said network control node.

150. The method according to claim 149, wherein said activity report includes a plurality of entries selected from the list consisting of:
number of times which at least one network connection between said repository network node and said network node, is disconnected in a given time period;
number of times which at least one network connection between said unoccupied repository network node, and said network node, is disconnected in a given time period;
bandwidth of at least one other network connection between said repository network node and said network control node;
bandwidth of at least one other network connection between said unoccupied repository network node and said network control node;
network protocol address of said network node, which sends an upload request to said repository network node, in a given time period, to upload said modified copy;
most popular ones of said infringing item which said network node requests from said repository network node, in a given time period;
most popular ones of said modified copy which said repository network node uploads to said network node, in a given time period; and
most popular ones of said modified copy which said unoccupied repository network node uploads to said network node, in a given time period.

151. The method according to claim 149, further comprising a step of monitoring the activity of a selected repository network node, by said network control node, by comparing said activity report of said selected repository network node, with said activity report of another selected repository network node.

152. The method according to claim 151, further comprising a step of adjusting the load on said selected repository network node, by said network control node, according to the outcome of said comparison step.

153. The method according to claim 149, further comprising a step of ratting the activity of a selected repository network node, by said network control node, by comparing said activity report of said selected repository network node, with said activity report of another selected repository network node.

154. The method according to claim 153, further comprising a step of determining by said network control node, whether to offer a reward to said selected repository network node, according to the outcome of said comparison step.

155. The method according to claim 124, further comprising a step of degenerating the routing capacity by said repository network node, when the resources thereof are restricted.

156. The method according to claim 155, wherein the type of said resources is selected from the list consisting of:
bandwidth;
memory; and
processing time.

157. The method according to claim 126, further comprising a step of degenerating the routing capacity by said unoccupied repository network node, when the resources thereof are restricted.

158. The method according to claim 157, wherein the type of said resources is selected from the list consisting of:
bandwidth;
memory; and
processing time.

159. The method according to claim 124, further comprising a preliminary step of signing said modified copy with a digital signature, by said network control node, whereby said network control node identifies said modified copy,
wherein said modified copy resides in a selected one of said network nodes.

160. The method according to claim 124, wherein said step of uploading further comprises a procedure of directing a different repository network node to upload the remaining portion of said modified copy to said network node, when said repository network node ceases to upload said modified copy to said network node, during said step of uploading,
wherein said step of directing is performed by said network control node.

161. The method according to claim 124, wherein said step of uploading further comprises a procedure of continuing the uploading of the remaining portion of said modified copy to said network node, by said network control node, when said repository network node ceases to upload said modified copy to said network node, during said step of uploading.

162. The method according to claim 128, wherein said step of uploading by said unoccupied repository network node further comprises a procedure of directing a different unoccupied repository network node to upload the remaining portion of said modified copy to said network node, when said unoccupied repository network node ceases to upload said modified copy to said network node, during said step of uploading,
wherein said step of directing is performed by said network control node.

163. The method according to claim 128, wherein said step of uploading by said unoccupied repository network node further comprises a procedure of continuing the uploading of the remaining portion of said modified copy to said network node, by said network control node, when said unoccupied repository network node ceases to upload said modified copy to said network node, during said step of uploading.

164. Method for rewarding a repository network node coupled to a network, for uploading an item to a network node coupled to the network, the method comprising the steps of:
analyzing uploading parameters received from said repository network node,
determining a reward according to the analysis of said uploading parameters; and
uploading said reward to said repository network node.

165. The method according to claim 164, wherein said reward is selected from the list consisting of:
IP protected item;
license to use said IP protected item;
screen saver including a changing content;
movie ticket; and
financial incentive.

166. The method according to claim 165, wherein said changing content is selected from the list consisting of:
advertisement; and
said IP protected item.
